(19) United States
(12) Patent Application Publication
(10) Pub. No.: US 2021/0168396 A1
(43) Pub. Date: Jun. 3, 2021

(54) IMAGE PROCESSING DEVICE AND METHOD

(71) Applicant: Sony Corporation, Tokyo (JP)

(72) Inventor: Kenji KONDO, Tokyo (JP)

(73) Assignee: Sony Corporation, Tokyo (JP)

(21) Appl. No.: 16/641,649

(22) PCT Filed: Aug. 24, 2018
(86) PCT No.: PCT/JP2018/031284

§ 371 Date: Feb. 25, 2020

(30) Foreign Application Priority Data
Sep. 8, 2017 (JP) 2017-173132

(51) Int. Cl. H04N 19/513; H04N 19/176; H04N 19/105; H04N 19/119

(52) U.S. Cl. CPC H04N 19/513; H04N 19/119; H04N 19/105; H04N 19/176

(57) ABSTRACT

The present technology relates to an image processing device and a method that allow the accuracy of motion compensation to be increased.

The image processing device includes a prediction unit that derives, by first block matching using a reference image, a motion vector of a block to be processed, and derives a motion vector of a portion of subblocks by using second block matching different from the first block matching. The subblocks are included in that block. The present technology is applicable to an image encoding device and an image decoding device.

### TECHNICAL FIELD

The present technology relates to an image processing device and a method, and more particularly to an image processing device and a method that allow the accuracy of motion compensation to be increased.

### BACKGROUND ART

For example, technology called FRUC (Frame Rate Up Conversion) has been proposed as technology related to image encoding and decoding. This FRUC technology is technology proposed in JVET (Joint Video Exploration Team), and the FRUC technology causes a decoder side to predict motion information during inter-prediction (see, for example, NPL 1).

The FRUC technology causes a decoder to perform a block matching process by template matching or bilateral matching to derive motion information. If the decoder derives motion information in this manner, it is possible to reduce information regarding the motion information stored in the bit stream.

### CITATION LIST

### Non-Patent Literature

NPL 1: Joint Video Exploration Team (JVET) of ITU-T SG 16 WP 3 and ISO/IEC JTC 1/SC 29/WG 11, “Algorithm Description of Joint Exploration Test Model 4”, JVET-D1001 v3, 4th Meeting: Chengdu, CN, 15-21 Oct. 2016

### SUMMARY OF THE INVENTION

### Problems to be Solved by the Invention

The FRUC technology described above derives motion information by using block matching in Coding Units (CUs), and then divides a block and performs block matching in units of subblocks to derive motion information in units of subblocks.

The scheme of block matching performed in CUs is also then adopted for subblocks, and the derivation accuracy of motion vectors is thus sometimes lowered in accordance with the positions of subblocks in the block.

The present technology has been devised in view of such circumstances to allow the accuracy of motion compensation to be increased.

### Means for Solving the Problems

An image processing device according to a first aspect of the present technology includes a prediction unit that derives, by first block matching using a reference image, a motion vector of a block to be processed, and derives a motion vector of a portion of subblocks by using second block matching different from the first block matching. The subblocks are included in the block.

In the first aspect of the present technology, the motion vector of the block to be processed is derived by the first block matching using the reference image. In addition, the motion vector of the portion of the subblocks included in the block is derived by using the second block matching different from the first block matching.

An image processing device according to a second aspect of the present technology includes a prediction unit that derives, by block matching using a reference image, a motion vector of a block to be processed, and prohibits the block from being divided into subblocks, or increases or decreases a number of divisions of the block for dividing the block into subblocks, in accordance with POC distance. The POC distance indicates a time interval between images used for the block matching.

In the second aspect of the present technology, the motion vector of the block to be processed is derived by the block matching using the reference image. In addition, the block is prohibited from being divided into subblocks, or the number of divisions of the block for dividing the block into subblocks is increased or decreased in accordance with the POC distance. The POC distance indicates the time interval between the images used for the block matching.

### Effects of the Invention

According to the present technology, it is possible to increase the accuracy of motion compensation.

It should be noted that the effects described here are not necessarily limitative, but may be any of effects described in the present disclosure.

### BRIEF DESCRIPTION OF DRAWING

FIG. 1 is a diagram illustrating a configuration example of an image encoding device.

FIG. 2 is a diagram describing bilateral matching.

FIG. 3 is a diagram describing template matching.

FIG. 4 is a diagram describing template matching performed in units of subblocks.

FIG. 5 is a diagram separately illustrating a subblock having a template and a subblock having no template.

FIG. 6 is a diagram illustrating a configuration example of a prediction unit.

FIG. 7 is a flowchart describing an image encoding process.

FIG. 8 is a flowchart describing an inter-prediction processing mode setting process.

FIG. 9 is a flowchart describing an FRUC mode encoding process.

FIG. 10 is a flowchart describing a motion information derivation process by the template matching.

FIG. 11 is a flowchart describing a subblock motion information derivation process by template matching in step S138 of FIG. 10.

FIG. 12 is a flowchart describing a subblock motion information derivation process by bilateral matching in step S139 of FIG. 10.

FIG. 13 is a flowchart describing a motion information derivation process by the bilateral matching.

FIG. 14 is a diagram illustrating a configuration example of an image decoding device.

FIG. 15 is a diagram illustrating a configuration example of the prediction unit.

FIG. 16 is a flowchart describing an image decoding process.

FIG. 17 is a flowchart describing an FRUC mode decoding process.

FIG. 18 is a flowchart describing the motion information derivation process by the template matching.

FIG. 19 is a flowchart describing a subblock motion information derivation process by template matching in step S278 of FIG. 10.

FIG. 20 is a flowchart describing a subblock motion information derivation process by bilateral matching in step S279 of FIG. 18.

FIG. 21 is a flowchart describing the motion information derivation process by the bilateral matching.

FIG. 22 is a diagram describing influence of size of a subblock in template matching.

FIG. 23 is a diagram illustrating a table of a relationship between each type of block matching and the size of a subblock in an FRUC mode.

FIG. 24 is a flowchart describing the motion information derivation process by the template matching of the image encoding device.

FIG. 25 is a flowchart describing the motion information derivation process by the template matching of the image decoding device.

FIG. 26 is a diagram illustrating an example of bilateral matching performed in units of subblocks.

FIG. 27 is a flowchart describing the motion information derivation process by the image encoding device by the template matching.

FIG. 28 is a flowchart describing the motion information derivation process by the image decoding device by the template matching.

FIG. 29 is a diagram illustrating a size example of a subblock in CU.

FIG. 30 is a diagram illustrating an example of block matching in a case of a POC distance of 1.

FIG. 31 is a diagram illustrating an example of block matching in a case of a POC distance of 2.

FIG. 32 is a diagram illustrating an example of a relationship between the POC distance and subblock size.

FIG. 33 is a diagram illustrating an example of a relationship between size of CU, the POC distance, and division into subblocks.

FIG. 34 is a diagram illustrating an example of a relationship between the bilateral matching, the size of CU, the POC distance, and the division into subblocks.

FIG. 35 is a diagram illustrating an example of a relationship between the template matching, the size of CU, the POC distance, and the division into subblocks.

FIG. 36 is a diagram illustrating a configuration example of a computer.

### MODES FOR CARRYING OUT THE INVENTION

Hereinafter, an embodiment to which the present technology is applied will be described with reference to the drawings. Description is given in the following order.

### 1. First Embodiment (Block Matching of Subblocks in Case of Template Matching)

### 2. Second Embodiment (Size of Subblocks in Template Matching)

### 3. Third Embodiment (Block Matching of Subblocks in Case of Bilateral Matching)

### 4. Fourth Embodiment (Size of Subblocks and POC Distance)

### 5. Fifth Embodiment (Size and Number of Divisions of CU)

### 6. Sixth Embodiment (Block Matching Type, and Size and Number of Divisions of CU)

### 7. Configuration Example of Computer

### First Embodiment

### <Configuration Example of Image Encoding Device>

An image encoding device serving as an image processing device to which the present technology is applied is described.

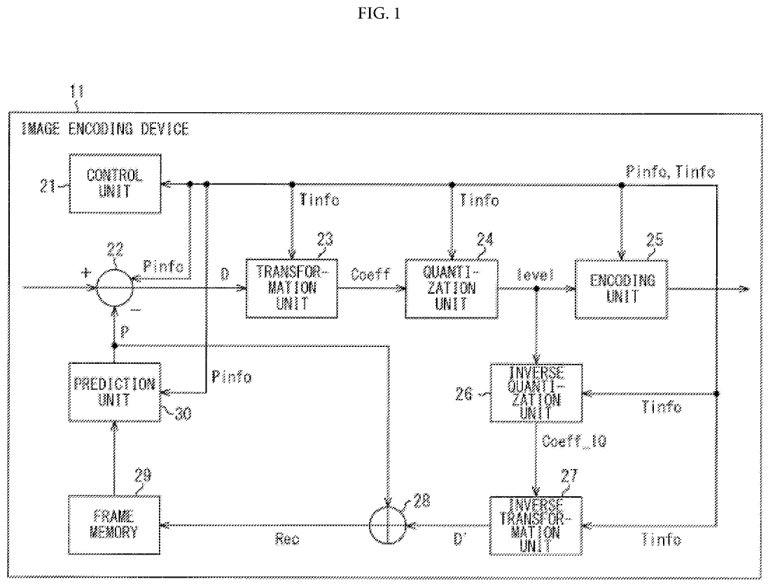

FIG. 1 is a diagram illustrating a configuration example of an image encoding device according to an embodiment to which the present technology is applied.

An image encoding device 11 illustrated in FIG. 1 is an encoder that encodes a prediction residual between an image and a predicted image thereof like AVC (Advanced Video Coding) or HEVC (High Efficiency Video Coding). For example, the image encoding device 11 implements the HEVC technology and the technology proposed in JVET.

In the image encoding device 11, a moving image to be processed is encoded in an inter-prediction mode or an intra-prediction mode. When a moving image is encoded or decoded, a picture corresponding to a frame included in the moving image is divided into slices, each of the slices is further divided into processing units (coding units) called CUs (Coding Units), and encoded and decoded in units of CUs. CU is divided into blocks called PUs (Prediction Units). In the technology under consideration in the next-generation standardization, CU and PU have the same block size, and the description is thus made assuming CU (=PU) unless otherwise specified.

CU is a block, having variable size, which is formed by recursively dividing CTU (Coding Tree Unit) serving as a maximum coding unit. Unless otherwise specified, the following refers to CTU simply as CU, and refers to CUs obtained by dividing CTU as subblocks. In addition, the following refers to CU and a subblock simply as block when there is no need to particularly distinguish them from each other.

Further, the inter-prediction mode includes, for example, a plurality of modes such as an AMVP (Advanced Motion Vector Prediction) mode and an FRUC (Frame Rate Up Conversion) mode, and encoding and decoding are performed in accordance with any of these plurality of modes.

The AMVP mode is a mode in which a prediction residual, a candidate for a motion vector for obtaining a motion vector, and a differential motion vector are stored in a bit stream for a block in a picture. That is, a candidate for a motion vector and a differential motion vector are stored in a bit stream as motion information.

Here, as information indicating a candidate for a motion vector, an index or the like indicating one of a plurality of surrounding regions around a block to be processed is stored in a bit stream. In the AMVP mode, a vector obtained by adding a differential motion vector to the motion vector of a surrounding region that is a candidate for the motion vector is used at the time of decoding as the motion vector of the block to be processed.

The FRUC mode is a mode in which FRUC_Mode_flag indicating which of template matching and bilateral matching is used to derive motion information, a prediction residual, and a differential motion vector are stored in a bit stream for a block in a picture. This FRUC mode is a mode in which motion information is derived on a decoder side on the basis of the AMVP mode. In addition, in the FRUC mode, the differential motion vector is not necessarily stored in the bit stream.

It should be noted that FIG. 1 mainly illustrates a processing unit, the flow of data, and the like, but FIG. 1 does not necessarily illustrate everything. That is, the image encoding device 11 may include a processing unit that is not illustrated as a block in FIG. 1 or there may be flows of processes and data that are not indicated by arrows and the like in FIG. 1.

The image encoding device 11 includes a control unit 21, a calculation unit 22, a transformation unit 23, a quantization unit 24, an encoding unit 25, an inverse quantization unit 26, an inverse transformation unit 27, a calculation unit 28, a frame memory 29, and a prediction unit 30. The image encoding device 11 performs encoding for each CU or subblock on a picture that is an inputted moving image in units of frames.

Specifically, the control unit 21 of the image encoding device 11 sets encoding parameters including header information Hinfo, prediction information Pinfo, transformation information Tinfo, and the like on the basis of input or the like from the outside.

The header information Hinfo, for example, includes information such as VPS (Video Parameter Set), a sequence parameter set (SPS (Sequence Parameter Set)), a picture parameter set (PPS (Picture Parameter Set)), and a slice header (SH).

The prediction information Pinfo includes, for example, split flag indicating the presence or absence of division in the horizontal direction or the vertical direction in each division hierarchy at the time of formation of a subblock (PU (Prediction Unit)). Furthermore, the prediction information Pinfo includes mode information pred_mode_flag indicating whether the prediction process of the block is an intra-prediction process or an inter-prediction process, for each block.

In a case where the mode information pred_mode_flag indicates an inter-prediction process, the prediction information Pinfo includes FRUC_flag, FRUC_Mode_flag, motion vector information, reference image specifying information for specifying a reference image (reference picture), and the like.

FRUC_flag is flag information indicating whether or not it is the FRUC mode. For example, in a case where it is the FRUC mode, the value of FRUC_flag is 1. In a case where it is not the FRUC mode, the value of FRUC_flag is 0.

FRUC_Mode_flag is flag information indicating which of template matching or bilateral matching is used to derive motion information in a case where it is the FRUC mode. For example, in a case where motion information is derived by bilateral matching, the value of FRUC_Mode_flag is 1. In a case where motion information is derived by template matching, the value of FRUC_Mode_flag is 0.

The motion vector information is information including at least one of the candidate for the motion vector or the differential motion vector described above.

In a case where the mode information pred_mode_flag indicates an intra-prediction process, the prediction information Pinfo includes intra-prediction mode information or the like indicating the intra-prediction mode that is a mode for the intra-prediction process. Needless to say, the prediction information Pinfo may have any contents, and this prediction information Pinfo may include any information other than that of the above-described example.

The transformation information Tinfo includes TBSize or the like indicating the size of a processing unit (transformation block) called TB (Transform Block). The TB per luminance (Y) and color difference (Cb, Cr) is included in TU (Transform Unit) that is a processing unit of an orthogonal transformation process, but the TU is assumed here to be the same as a subblock.

In addition, in the image encoding device 11, a picture of a moving image to be encoded is supplied to the calculation unit 22.

The calculation unit 22 sequentially treats the inputted pictures as pictures to be encoded, and sets blocks to be encoded, that is, CUs or subblocks for the pictures to be encoded on the basis of split flag of the prediction information Pinfo. The calculation unit 22 subtracts a predicted image P in units of blocks supplied from the prediction unit 30 from an image I (also referred to as current block below) of the blocks to be encoded to obtain a prediction residual D, and supplies the transformation unit 23.

On the basis of the transformation information Tinfo supplied from the control unit 21, the transformation unit 23 performs orthogonal transformation or the like on the prediction residual D supplied from the calculation unit 22, derives a transformation coefficient Coeff, and supplies the quantization unit 24.

On the basis of the transformation information Tinfo supplied from the control unit 21, the quantization unit 24 scales (quantizes) the transformation coefficient Coeff supplied from the transformation unit 23, and derives a quantization transformation coefficient level level. The quantization unit 24 supplies the quantization transformation coefficient level level to the encoding unit 25 and the inverse quantization unit 26.

The encoding unit 25 encodes the quantization transformation coefficient level level or the like supplied from the quantization unit 24 in a predetermined method. For example, the encoding unit 25 transforms the encoding parameters supplied from the control unit 21 and the quantization transformation coefficient level level supplied from the quantization unit 24 into the syntax values of the respective syntax elements in accordance with the definition of a syntax table. The encoding parameters include the header information Hinfo, the prediction information Pinfo, the transformation information Tinfo, and the like. Then, the encoding unit 25 encodes the respective syntax values through arithmetic encoding or the like.

The encoding unit 25 multiplexes, for example, encoded data that is a bit string of each syntax element obtained as a result of encoding, and outputs the multiplexed data as an encoded stream.

On the basis of the transformation information Tinfo supplied from the control unit 21, the inverse quantization unit 26 scales (inversely quantizes) a value of the quantization transformation coefficient level level supplied from the quantization unit 24, and derives a transformation coefficient Coeff IQ after the inverse quantization. The inverse quantization unit 26 supplies the transformation coefficient Coeff IQ to the inverse transformation unit 27. This inverse quantization performed by the inverse quantization unit 26 is an inverse process of the quantization performed by the quantization unit 24, and is a process similar to the inverse quantization performed in the image decoding device described below.

On the basis of the transformation information Tinfo supplied from the control unit 21, the inverse transformation unit 27 performs inverse orthogonal transformation and the like on the transformation coefficient Coeff IQ supplied from the inverse quantization unit 26, and derives a prediction residual D′. The inverse transformation unit 27 supplies the prediction residual D′ to the calculation unit 28.

This inverse orthogonal transformation performed by the inverse transformation unit 27 is an inverse process of the orthogonal transformation performed by the transformation unit 23, and is a process similar to the inverse orthogonal transformation performed in the image decoding device described below.

The calculation unit 28 adds the prediction residual D′ supplied from the inverse transformation unit 27 and the predicted image P corresponding to the prediction residual D′ supplied from the prediction unit 30 together, and derives a local decoded image Rec. The calculation unit 28 supplies the local decoded image Rec to the frame memory 29.

The frame memory 29 reconstructs a decoded image in picture units by using the local decoded image Rec supplied from the calculation unit 28, and stores the reconstructed image in a buffer in the frame memory 29.

The frame memory 29 reads out the decoded image designated by the prediction unit 30 as a reference image (reference picture) from the buffer, and supplies the prediction unit 30. In addition, the frame memory 29 may store the header information Hinfo, the prediction information Pinfo, the transformation information Tinfo, and the like for the generation of the decoded image in the buffer in the frame memory 29.

On the basis of the mode information pred_mode_flag of the prediction information Pinfo, the prediction unit 30 acquires, as a reference image, the decoded image at the same time as that of the block to be encoded stored in the frame memory 29. Then, using the reference image, the prediction unit 30 performs, on the block to be encoded, an intra-prediction process in the intra-prediction mode indicated by the intra-prediction mode information.

Furthermore, on the basis of the mode information pred_mode_flag of the prediction information Pinfo and the reference image specifying information, the prediction unit 30 acquires, as a reference image, the decoded image different in time from that of the block to be encoded stored in the frame memory 29. The prediction unit 30 performs an inter-prediction process on the reference image in a mode determined by FRUC_flag on the basis of FRUC_flag, FRUC_Mode_flag, the motion vector information, and the like.

The prediction unit 30 supplies the predicted image P of the block to be encoded generated as a result of the intra-prediction process or the inter-prediction process to the calculation unit 22 and the calculation unit 28.

### <Regarding FRUC Mode>

Here, the FRUC mode is described.

For example, in the inter-prediction, motion information such as a motion vector or a reference index is necessary on the decoder side to perform motion compensation.

Normally, the motion information is included in the encoded stream in the form of differential motion vector information with a candidate for a motion vector, and the decoder reconfigures the motion vector on the basis of the candidate for the motion vector and the differential motion vector information.

Storing the differential motion vector in the encoded stream increases the code amount of the encoded stream, deteriorating the coding efficiency.

The FRUC technology is one of methods of predicting motion information, that is, deriving motion information. Deriving the motion information on the decoder side through the FRUC technology makes it possible to not only predict the motion vector with high accuracy, but also reduce the code amount of the motion information, allowing the coding efficiency to be increased.

As described above, in the FRUC mode, the encoder side is able to select any block matching of bilateral matching and template matching, and the decoder side derives the motion information in the method designated by the encoder side.

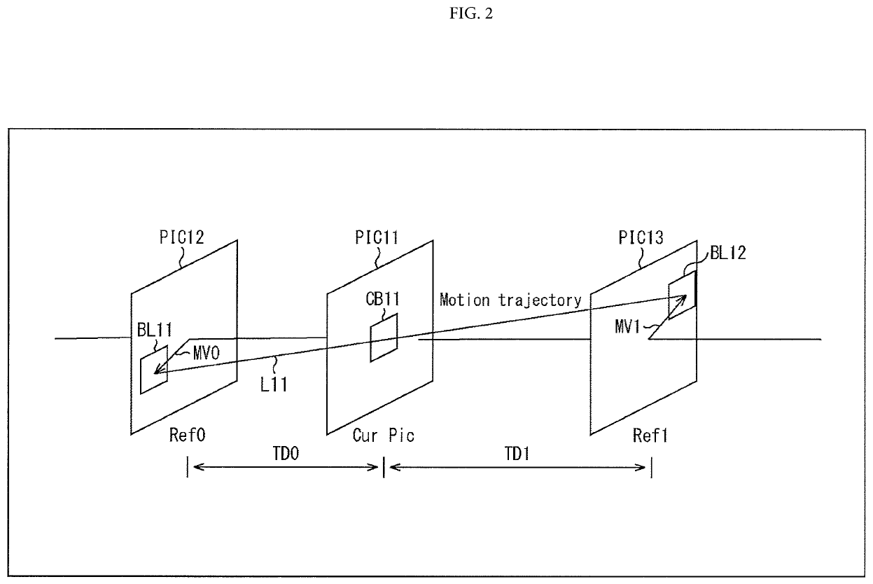

A picture PIC11, and a picture PIC12 and a picture PIC13 are used in bilateral matching as illustrated in FIG. 2 to derive the motion vector of a current block CB11 on the picture PIC11. The picture PIC11 is a picture (frame) to be encoded. The picture PIC12 and the picture PIC13 are reference pictures.

It should be noted that FIG. 2 illustrates time as the horizontal direction. In this example, the picture PIC12 is a frame at earlier time than the picture PIC11 in the display order, and the picture PIC13 is a frame at later time than the picture PIC11 in the display order.

In particular, the picture PIC12 is a picture (frame) indicated as a reference picture by a reference list RefO serving as reference image specifying information. In contrast, the picture PIC13 is a picture (frame) indicated as a reference picture by a reference list Refl serving as reference image specifying information.

Here, the reference list RefO is basically a list indicating a frame older than the picture PIC11 to be encoded as a reference picture. It is possible in the reference list RefO to designate a plurality of pictures including a picture to be encoded as reference pictures.

Similarly, the reference list Refl is basically a list indicating a frame newer than the picture PIC11 to be encoded as a reference picture. It is possible in the reference list Refl to designate a plurality of pictures including a picture to be encoded as reference pictures.

In addition, in the example illustrated in FIG. 2, TD0 represents the time distance between the picture PIC11 and the picture PIC12, and TD1 represents the time distance between the picture PIC11 and the picture PIC13. Here, for example, it is assumed that the time distance TD0 and the time distance TD1 are equal distance.

When the motion vector of the current block CB11 to be encoded is derived, a block BL11 and a block BL12 are selected for a straight line L11 passing through the center of the current block CB11. The block BL11 is a block whose center is the intersection with the straight line L11 in the picture PIC12, and the block BL12 is a block whose center is the intersection with the straight line L11 in the picture PIC13. Then, the difference between the block BL11 and the block BL12 is calculated.

Further, while the positions of the block BL11 and the block BL12 are shifted within a search range, the difference is calculated for every combination of the block BL11 and block BL12, and the combination having the smallest difference is searched for. Then, a vector indicating the blocks in the combination having the smallest difference is a motion vector to be obtained.

It should be noted that the respective blocks are then selected to cause the straight line coupling the center of the block BL11 and the center of the block BL12 to each other to pass through the center of the current block CB11 without fail. That is, the difference between the block BL11 and the block BL12 linearly coupling the current block CB11 is calculated.

In this example, as the motion vector of the current block CB11, a motion vector MV0 and a motion vector MV1 expressed by arrows in the diagram are obtained.

The motion vector MV0 is a vector in which a position on the picture PIC12 in the same positional relationship as that of the central position of the current block CB11 is used as a start point, and the position at the center of the block BL11 is used as an end point. Similarly, the motion vector MV1 is a vector in which a position on the picture PIC13 in the same positional relationship as that of the central position of the current block CB11 is used as a start point, and the position at the center of the block BL12 is used as an end point.

In this manner, bilateral matching assumes a model in which the texture linearly moves between the picture PIC12 and the picture PIC13, and this model is applied to an object in motion (moving) at constant speed.

As described above, in bilateral matching, the motion vector is derived by block matching using two reference pictures different in display time from the picture to be encoded and different in display time from each other while changing blocks the difference between which is to be calculated. This allows not only the encoder side, but also the decoder side to derive (predict) the motion vector with high accuracy.

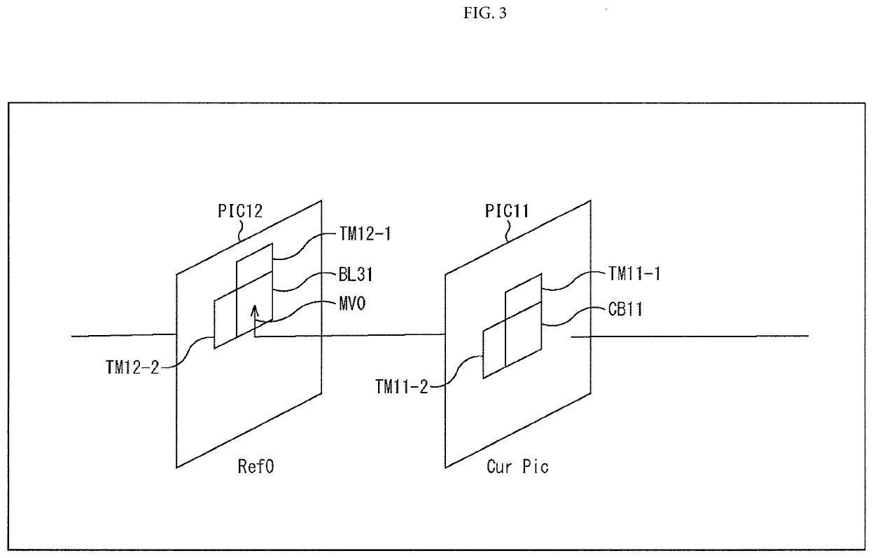

In addition, in template matching, block matching is performed between a picture to be encoded and a reference picture different in display time from the picture to be encoded, for example, as illustrated in FIG. 3. It should be noted that, in FIG. 3, portions corresponding to those in the case in FIG. 2 are denoted with the same reference numerals, and the description thereof is omitted as appropriate.

In the example illustrated in FIG. 3, the current block CB11 of the picture PIC11 is to be encoded, and block matching is performed between this picture PIC11 and the picture PIC12.

In block matching, a region TM11-1 and a region TM11-2 adjacent to the current block CB11 on the picture PIC11 are templates that are regions used for block matching, that is, the calculation of the difference. It should be noted that, in a case where there is no need to particularly distinguish the region TM11-1 and the region TM11-2 from each other, the following also refers to them simply as regions TM11.

This region TM11 is a region that has been encoded or decoded before the time when the current block CB11 is to be processed.

In addition, in the picture PIC12 that is a reference picture, a region TM12-1 and a region TM12-2 having the same size and shape as those of the region TM11-1 and the region TM11-2 are templates.

It should be noted that the shape and size of the region TM12-1 are the same as the shape and size of the region TM11-1, and the shape and size of the region TM12-2 are the same as the shape and size of the region TM11-2. Furthermore, the relative positional relationship between the region TM12-1 and the region TM12-2 is the same as the relative positional relationship between the region TM11-1 and the region TM11-2.

In a case where there is no need to particularly distinguish the region TM12-1 and the region TM12-2 from each other, the following also refers to them simply as regions TM12.

In template matching, while shifting the position of the region TM12 within a predetermined search range, the difference between the region TM11 and the region TM12 in the same shape is calculated at each position, and the position of the region TM12 at which the difference is the smallest is searched for.

In this example, when the differences are calculated, the difference between the region TM11-1 and the region TM12-1 and the difference between the region TM11-2 and the region TM12-2 are calculated.

Then, the vector indicating the position of the region TM12 at which the difference is the smallest is set as a motion vector to be obtained. In this example, as the motion vector of the current block CB11, the motion vector MV0 expressed by an arrow in the diagram is obtained.

For example, as a block BL31, a block is set having the same shape and size as those of the current block CB11 and having the same relative positional relationship with a region TM12 in the picture PIC12 as the relative positional relationship between the region TM11 and the current block CB11. In addition, it is assumed that the difference between the region TM11 and the region TM12 is the smallest when the region TM12 and the block BL31 are located at the positions illustrated in FIG. 3.

In this case, as the motion vector MV0, a vector is set in which a position on the picture PIC12 in the same positional relationship as that of the central position of the current block CB11 is used as a start point and the position of the center of the block BL31 is used as an end point.

As described above, in template matching, the motion vector is derived by block matching using one reference picture different in display time from a picture to be encoded while changing the template positions on the reference pictures the difference between which is to be calculated. This allows not only the encoder side, but also the decoder side to derive (predict) the motion vector with high accuracy.

### <Process of Subblock in Case of Template Matching>

In the FRUC mode under consideration in JVET, the block matching described above is performed in CUs, the blocks are then further divided, and block matching is performed in units of subblocks to derive the motion information in units of subblocks.

That is, in a case where template matching is used to derive the motion information of CUs, the template matching is also used in subblocks to derive the motion information of the subblocks.

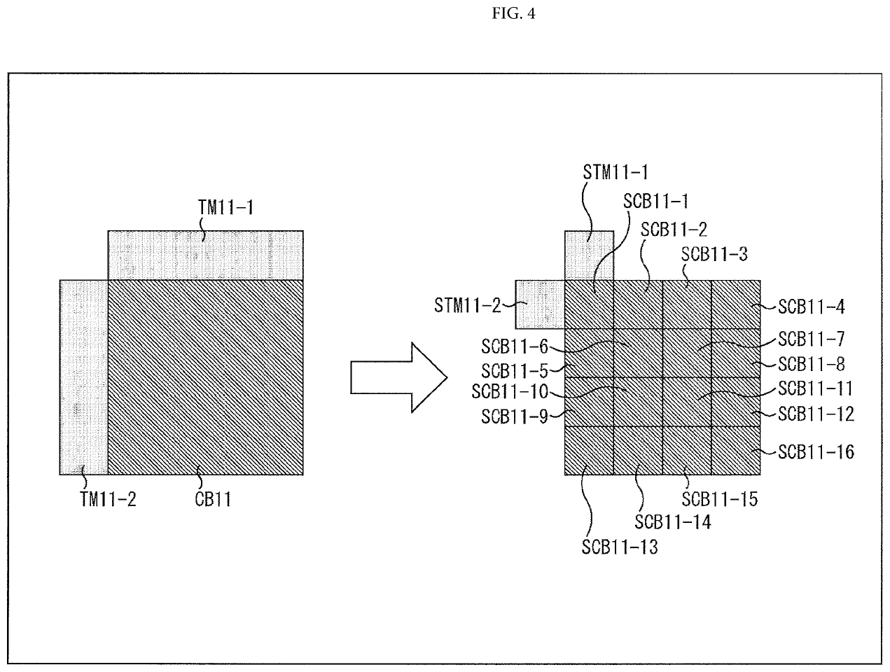

FIG. 4 is a diagram illustrating an example of template matching performed in units of subblocks. It should be noted that, in FIG. 4, portions corresponding to those in the case in FIG. 3 are denoted with the same reference numerals, and the description thereof is omitted as appropriate.

The left side of FIG. 4 illustrates the current block CB11, and the region TM11-1 and the region TM11-2 that are adjacent to the current block CB11 and are used for template matching.

The right side of FIG. 4 illustrates subblocks SCB11-1 to SCB11-16 obtained by dividing the current block CB11 into 16. The subblock SCB11-1 is a subblock positioned on the upper left of the current block CB11. The subblock SCB11-2 is the subblock positioned on the right side of the subblock SCB11-1. The subblock SCB11-3 is the subblock positioned on the right side of the subblock SCB11-2. The subblock SCB11-4 is the subblock positioned on the right side of the subblock SCB11-3.

The subblock SCB11-1 to the subblock SCB11-4 are the subblocks positioned on the uppermost portion of the current block CB11.

The subblock SCB11-5 is the subblock positioned below the subblock SCB11-1. The subblock SCB11-6 is the subblock positioned on the right side of the subblock SCB11-5. The subblock SCB11-7 is the subblock positioned on the right side of the subblock SCB11-6. The subblock SCB11-8 is the subblock positioned on the right side of the subblock SCB11-7.

The subblock SCB11-9 is the subblock positioned below the subblock SCB11-5. The subblock SCB11-10 is the subblock positioned on the right side of the subblock SCB11-9. The subblock SCB11-11 is the subblock positioned on the right side of the subblock SCB11-10. The subblock SCB11-12 is the subblock positioned on the right side of the subblock SCB11-11.

The subblock SCB11-13 is the subblock positioned below the subblock SCB11-9. The subblock SCB11-14 is the subblock positioned on the right side of the subblock SCB11-13. The subblock SCB11-15 is the subblock positioned on the right side of the subblock SCB11-14. The subblock SCB11-16 is the subblock positioned on the right side of the subblock SCB11-15.

The subblocks SCB11-1, SCB11-5, SCB11-9, and SCB11-13 are the blocks positioned on the leftmost portion of the current block CB11.

In addition, a region STM11-1 and a region STM11-2 are illustrated that are adjacent to the subblock SCB11-1 positioned on the upper left position of the current block CB11 and are templates used for the template matching of the subblock SCB11-1.

As described above with reference to FIG. 3, template matching is first performed in units of CUs to obtain an optimal motion vector MV0 of the current block CB11. The optimal motion vector MV0 obtained with the current block CB11 is used to further perform template matching for the respective subblocks SCB11-1 to SCB11-16 as indicated by the arrow of FIG. 4.

Template matching is performed in units of subblocks, thereby offering a motion vector in a smaller region. This makes it possible to perform motion compensation (MC (Motion Compensation)) with higher accuracy.

However, in the template matching performed in units of subblocks, template matching is performed in CUs and template matching is further performed with subblocks. Accordingly, there are templates only around the CUs.

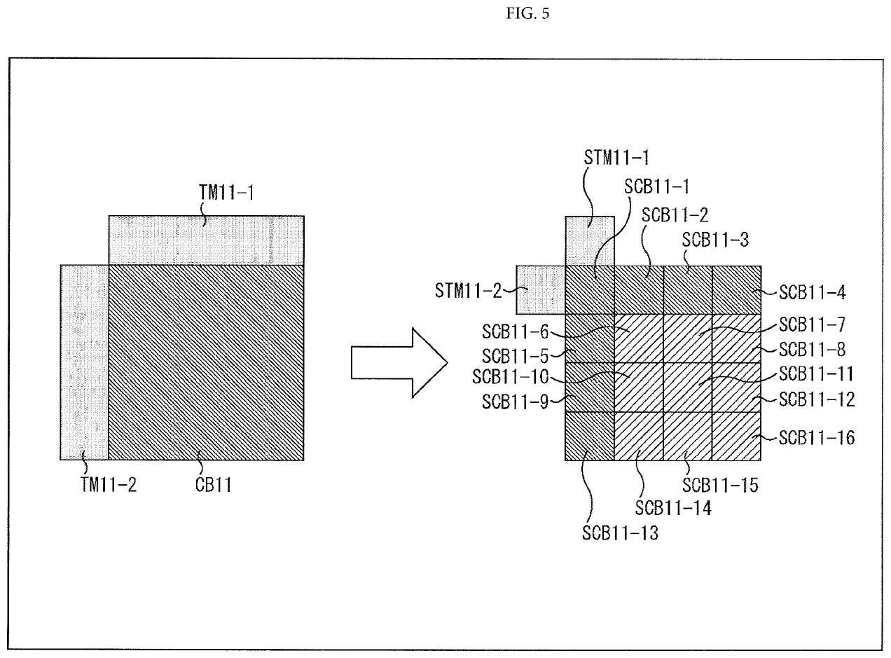

FIG. 5 is a diagram illustrating subblocks divided into subblocks each having a template and subblocks each having no template. It should be noted that, in FIG. 5, portions corresponding to those in the case in FIG. 4 are denoted with the same reference numerals, and the description thereof is omitted as appropriate. In FIG. 5, the subblocks each having a template and the subblocks each having no template are different from each other in hatching.

In the example of FIG. 5, the subblocks on the uppermost portion and the subblocks on the leftmost portion of the current block CB11 (subblocks SCB11-1 to SCB11-5, subblock SCB11-9, and subblock SCB11-13) each have an adjacent template. In contrast, the subblocks SCB11-6 to SCB11-8, the subblocks SCB11-10 to SCB11-12, and the subblocks SCB11-14 to SCB11-16 each have no adjacent template that is a reconstructed image of a template region in other words.

Template matching is impossible with these subblocks having no reconstructed images for templates, leading to risks of lower derivation accuracy of motion vectors and consequently lower accuracy of motion compensation.

Accordingly, in a first embodiment of the present technology, not only template matching, but bilateral matching are also used to derive the motion vector of a subblock when the motion vector of CU is derived by template matching.

For the subblocks SCB11-1 to SCB11-5, subblock SCB11-9, and subblock SCB11-13 each having the template illustrated in FIG. 5, the motion vectors are derived by template matching. For the subblocks SCB11-6 to SCB11-8, subblocks SCB11-10 to SCB11-12, and subblocks SCB11-14 to SCB11-16 each having no template, the motion vectors are derived by bilateral matching.

That is, to derive the motion vectors of the subblocks included in CU for which the motion vectors are derived by template matching, any one of template matching or bilateral matching is used in accordance with the positions of the subblocks in the CU. Alternatively, there is sometimes no template at the screen edge or the like. In this case, to derive the motion vectors of the subblocks included in CU for which the motion vectors are derived by template matching, any one of template matching or bilateral matching is used in accordance with whether or not the subblocks have templates.

This allows the derivation accuracy of the motion vectors of subblocks to be improved. Increasing the derivation accuracy of motion vectors also allows the accuracy of motion compensation to be increased.

### <Regarding Components of Prediction Unit>

Incidentally, in the prediction unit 30 of the image encoding device 11 described above, motion information, that is, a motion vector is derived by template matching or bilateral matching.

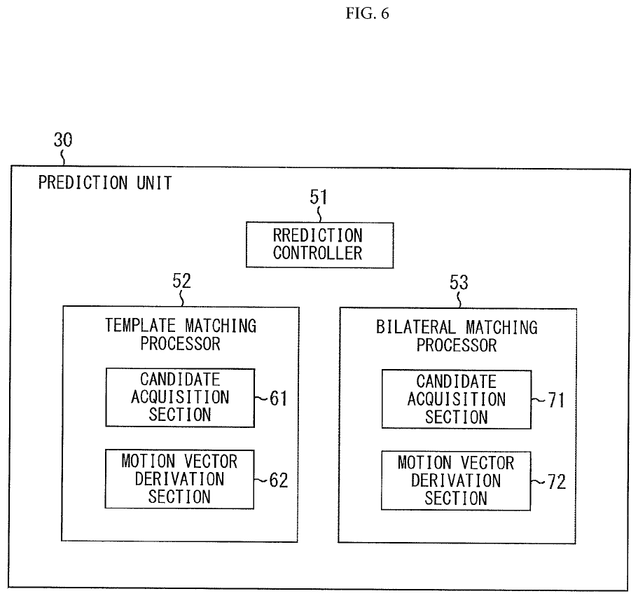

For example, the prediction unit 30 includes a component illustrated in FIG. 6 as a component that derives a motion vector by template matching or bilateral matching.

That is, in the example illustrated in FIG. 6, the prediction unit 30 includes a prediction controller 51, a template matching processor 52, and a bilateral matching processor 53.

The prediction controller 51 causes the template matching processor 52 or the bilateral matching processor 53 to derive a motion vector for CU (CTU) to be encoded.

The prediction controller 51 divides CU into subblocks on the basis of split flag of the prediction information Pinfo from the control unit 21. The prediction controller 51 causes the template matching processor 52 or the bilateral matching processor 53 to derive a motion vector for a divided subblock.

Specifically, for example, the prediction controller 51 causes the template matching processor 52 or the bilateral matching processor 53 to derive motion vectors for the divided subblocks in accordance with the positions of the subblocks in CU.

FIG. 5 illustrates a case where the position of a subblock is the position of any of the subblocks SCB11-1 to SCB11-5, subblock SCB11-9, and subblock SCB11-13. In a case of the position of any of these, the template matching processor 52 is caused to derive a motion vector for the divided subblock.

A case is illustrated where the position of a subblock is the position of any of the subblocks SCB11-6 to SCB11-8, subblocks SCB11-10 to SCB11-12, and subblocks SCB11-14 to SCB11-16. In a case of the position of any of these, the bilateral matching processor 53 is caused to derive a motion vector for the divided subblock.

Alternatively, the prediction controller 51 causes the template matching processor 52 or the bilateral matching processor 53 to derive a motion vector for a divided subblock in accordance with whether or not the subblock has a template.

In a case where the subblock has a template, the prediction controller 51 causes the template matching processor 52 to derive a motion vector for the divided subblock.

In a case where the subblock has no template, the prediction controller 51 causes the bilateral matching processor 53 to derive a motion vector for the divided subblock.

The template matching processor 52 derives a motion vector for CU or a subblock by using template matching in accordance with an instruction from the prediction controller 51. The template matching processor 52 includes a candidate acquisition section 61 and a motion vector derivation section 62.

The candidate acquisition section 61 collects the motion vector (also referred to as adjacent motion vector below) of the surrounding region adjacent to CU to be encoded as a candidate for the predicted motion vector, that is, a candidate for the start point. Here, the predicted motion vector is a motion vector derived for CU and a subblock. The following also refers to the motion vector derived for CU or a subblock as predicted motion vector as appropriate.

In a case where it is CU that is to be processed, the candidate acquisition section 61 generates a list of surrounding regions predefined for the CU to be processed as a list (also referred to as candidate list below) of candidates for the start point. The candidate acquisition section 61 acquires a candidate for the start point indicated by the generated candidate list, that is, the adjacent motion vector of the surrounding region, and supplies the motion vector derivation section 62.

In a case where it is a subblock that is to be processed, the candidate acquisition section 61 generates not only a list of surrounding regions predefined for the subblock to be processed, but also a subblock candidate list also including, as one candidate, the motion vector obtained for the CU including the subblock. The candidate acquisition section 61 acquires a candidate for the start point indicated by the generated subblock candidate list, that is, the adjacent motion vector of the surrounding region and the motion vector obtained for the CU, and supplies the motion vector derivation section 62.

The motion vector derivation section 62 selects one candidate from among a plurality of candidates for the predicted motion vector (candidates for the start point) indicated by the candidate list (or the subblock candidate list). The motion vector derivation section 62 obtains the predicted motion vector of CU (or subblock) to be encoded by template matching with a candidate for the predicted motion vector used as the start point.

That is, the motion vector derivation section 62 uses a region on a reference picture as a template. The region is determined by an adjacent motion vector that is the start point. Then, the motion vector derivation section 62 calculates the difference between the template of the reference picture and the template adjacent to the CU (or subblock) to be encoded by template matching, and calculates the cost obtained from a result of the calculation. For example, the cost obtained for the templates is smaller as the difference between the templates is smaller.

The motion vector derivation section 62 selects, from all the candidates for the start point, a candidate start point that causes the smallest cost as the predicted motion vector of the CU (or subblock) to be encoded.

Further, the motion vector derivation section 62 obtains the search range on the reference picture determined by the selected predicted motion vector, and obtains the final motion vector by template matching while moving the position of the template within the obtained search range.

The motion vector derivation section 62 uses, as a template, the region at a predetermined position within the obtained search range. Then, the motion vector derivation section 62 calculates the difference between the template of the reference picture and the template adjacent to the CU (or subblock) to be encoded by template matching while moving the position of the template within the search range. The motion vector derivation section 62 calculates the cost obtained from a result of the calculation. For example, the cost obtained for the templates is smaller as the difference between the templates is smaller.

The motion vector derivation section 62 uses, as the final motion vector of the CU (or subblock) to be encoded, the motion vector determined by the position of the template on the reference picture when the obtained cost is the smallest.

In the motion vector derivation section 62, as necessary, the difference between the finally obtained motion vector and the adjacent motion vector that is a candidate for the motion vector used to derive the motion vector is calculated as the differential motion vector of the CU (or subblock) to be encoded.

As described above, in the template matching processor 52, the derived motion vector and the differential motion vector are acquired as the motion information of the CU to be encoded. Further, the motion vector and differential motion vector derived by the template matching processor 52 are acquired as the motion information of the subblock to be encoded.

The bilateral matching processor 53 derives a motion vector for CU or a subblock by using bilateral matching in accordance with an instruction from the prediction controller 51. The bilateral matching processor 53 includes a candidate acquisition section 71 and a motion vector derivation section 72.

The candidate acquisition section 71 collects the adjacent motion vector that is the motion vector of the surrounding region adjacent to CU to be encoded as a candidate for the predicted motion vector, that is, a candidate for the start point.

In a case where it is CU that is to be processed, the candidate acquisition section 71 generates a list of surrounding regions predefined for the CU to be processed as a list (candidate list) of candidates for the start point. The candidate acquisition section 71 acquires a candidate for the start point indicated by the generated candidate list, that is, the adjacent motion vector of the surrounding region, and supplies the motion vector derivation section 72.

In a case where it is a subblock that is to be processed, the candidate acquisition section 71 generates not only a list of surrounding regions predefined for the subblock to be processed, but also a subblock candidate list also including, as one candidate, the motion vector obtained for the CU including the subblock. The candidate acquisition section 71 acquires a candidate for the start point indicated by the generated subblock candidate list, that is, the adjacent motion vector of the surrounding region and the motion vector obtained for the CU, and supplies the motion vector derivation section 72.

The motion vector derivation section 72 selects one candidate from among a plurality of candidates for the predicted motion vector (candidates for the start point) indicated by the candidate list (or the subblock candidate list). The motion vector derivation section 72 obtains the motion vector of CU (or subblock) to be encoded by bilateral matching with a candidate for the predicted motion vector used as the start point.

That is, the motion vector derivation section 72 uses regions (blocks) determined by adjacent motion vectors as difference calculation blocks. The regions are candidates for the start points on two reference pictures.

Then, the motion vector derivation section 72 calculates the difference between the difference calculation blocks on the two reference pictures by bilateral matching, and calculates the cost obtained from a result of the calculation. For example, the cost obtained for the difference calculation blocks is smaller as the difference between difference calculation blocks is smaller.

The motion vector derivation section 72 selects, from all the candidates for the start point, a candidate start point that causes the smallest cost as the predicted motion vector of the CU (or subblock) to be encoded.

The motion vector derivation section 72 obtains the search range on the reference picture determined by the selected predicted motion vector, and obtains the final motion vector by bilateral matching while moving the position of the difference calculation block within the obtained search range.

That is, the motion vector derivation section 72 uses the region on the reference picture determined by the selected predicted motion vector as a search range, and uses a block within the search range as a difference calculation block.

Then, the motion vector derivation section 72 calculates the difference between the difference calculation blocks of the two reference pictures by bilateral matching while moving the position of the difference calculation block within the search range, and calculates the cost obtained from a result of the calculation. For example, the cost obtained for the difference calculation blocks is smaller as the difference between difference calculation blocks is smaller.

The motion vector derivation section 72 uses, as the final motion vector of the CU (or subblock) to be encoded, the motion vector determined by the position of the difference calculation block on the reference picture when the obtained cost is the smallest.

In the motion vector derivation section 72, as necessary, the difference between the finally obtained motion vector and the adjacent motion vector that is a candidate for the motion vector used to derive the motion vector is calculated as the differential motion vector of the CU (or subblock) to be encoded.

As described above, in the bilateral matching processor 53, the derived motion vector and the differential motion vector are acquired as the motion information of the CU to be encoded. Further, the motion vector and differential motion vector derived by the bilateral matching processor 53 are acquired as the motion information of the subblock to be encoded.

### <Description of Image Encoding Process>

Next, the operation of the image encoding device 11 described above is described.

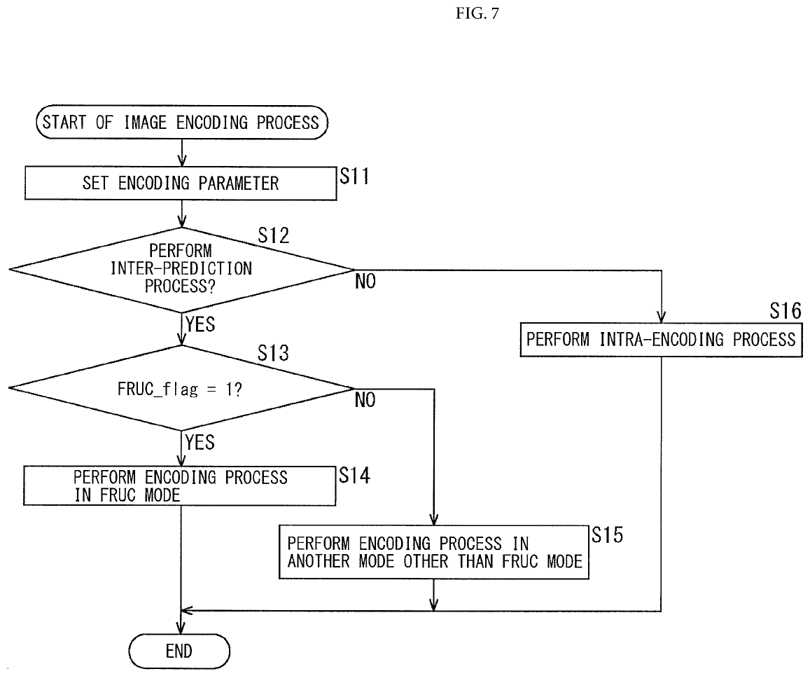

First, with reference to the flowchart of FIG. 7, the image encoding process by the image encoding device 11 is described. It should be noted that this image encoding process is performed in units of CUs or subblocks.

In step S11, the control unit 21 sets an encoding parameter on the basis of input or the like from the outside, and supplies the set encoding parameter to each unit of the image encoding device 11.

In step S11, for example, the header information Hinfo, prediction information Pinfo, transformation information Tinfo, or the like described above is set as an encoding parameter.

In step S12, the prediction unit 30 determines whether or not to perform an inter-prediction process, on the basis of the mode information pred_mode_flag of the prediction information Pinfo supplied from the control unit 21. For example, in a case where the value of the mode information pred_mode_flag indicates an inter-prediction process, it is determined in step S12 that an inter-prediction process is performed.

In a case where it is determined in step S12 that an inter-prediction process is performed, the prediction unit 30 determines in step S13 whether or not the value of FRUC_flag of the prediction information Pinfo supplied from the control unit 21 is 1, that is, whether or not FRUC_flag=1 is satisfied.

In a case where it is determined in step S13 that FRUC_flag=1 is satisfied, that is, in a case where it is determined that it is the FRUC mode, the process proceeds to step S14.

In step S14, each unit of the image encoding device 11 performs an encoding process of encoding the image I (current block) to be encoded in the FRUC mode, and the image encoding process ends.

In the encoding process in the FRUC mode, motion information is derived in the FRUC mode, and an encoded stream in which the prediction information Pinfo, the quantization transformation coefficient level level, and the like are stored is generated.

The prediction information Pinfo generated here includes, for example, FRUC_flag, FRUC_Mode_flag, and reference image specifying information, and also includes motion vector information as necessary. In addition, when the image I, that is, the current block is a P-slice block, the prediction information Pinfo does not include FRUC_Mode_flag.

In contrast, in a case where it is determined in step S13 that FRUC_flag=1 is not satisfied, that is, in a case where it is determined that FRUC_flag=0 is satisfied and it is not the FRUC mode, the process proceeds to step S15.

In step S15, each unit of the image encoding device 11 performs an encoding process of encoding the image I to be encoded in a mode such as an AMVP mode, for example, other than the FRUC mode, and the image encoding process ends.

In addition, in a case where it is determined in step S12 that no inter-prediction process is performed, that is, in a case where it is determined that an intra-prediction process is performed, the process proceeds to step S16.

In step S16, each unit of the image encoding device 11 performs an intra-encoding process of encoding the image I to be encoded in the intra-prediction mode, and the image encoding process ends.

In the intra-encoding process, the predicted image P is generated in the intra-prediction mode in the prediction unit 30. Then, the current block is encoded by using the predicted image P, and an encoded stream in which the prediction information Pinfo, the quantization transformation coefficient level level, and the like are stored is generated.

As described above, the image encoding device 11 encodes an image inputted in accordance with an encoding parameter, and outputs an encoded stream obtained by the encoding. Encoding an image in an appropriate mode in this manner allows the coding efficiency to be increased.

### <Description of Inter-prediction Processing Mode Setting Process>

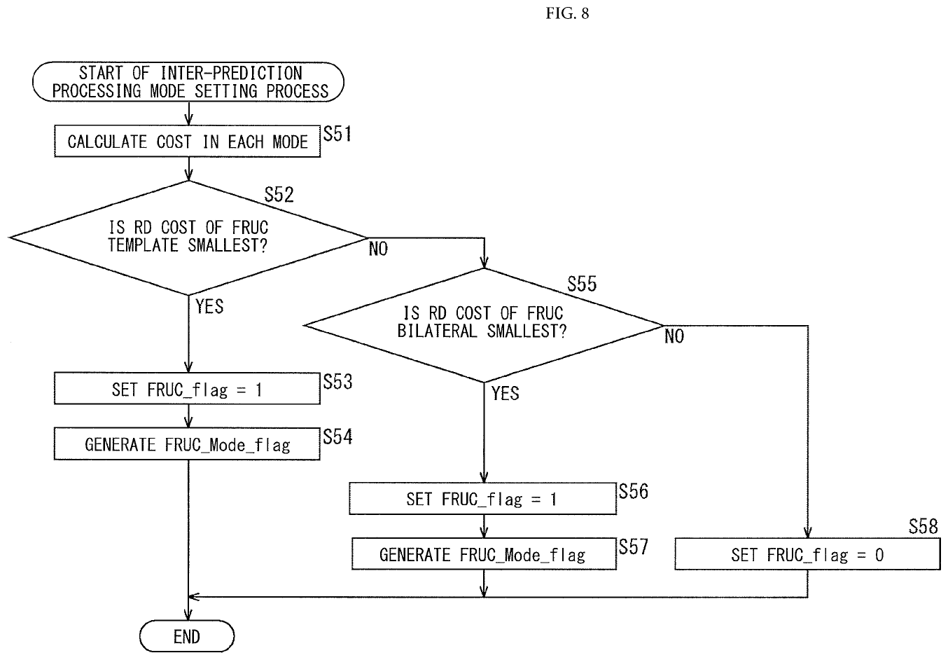

Next, with reference to the flowchart of FIG. 8, an inter-prediction processing mode setting process corresponding to the process in step S11 of FIG. 7 is described.

This inter-prediction processing mode setting process is the process of a portion of the process in step S11 of FIG. 7 regarding the inter-prediction processing mode. That is, the inter-prediction processing mode setting process is the process of a portion where the value of FRUC_flag is determined. In addition, the inter-prediction processing mode setting process is performed in units of CUs or subblocks.

In step S51, the control unit 21 controls each unit of the image encoding device 11 to cause an encoding process to be performed for a block to be encoded in each mode including the FRUC mode, and cause the RD cost in each mode to be calculated.

It should be noted the RD cost is calculated on the basis of a generated bit amount (code amount) obtained as a result of the encoding, SSE (Error Sum of Squares) of the decoded image, and the like.

In step S52, the control unit 21 determines whether or not the RD cost obtained when template matching is adopted to derive the motion information in the FRUC mode (referred to as FRUC template below) is the smallest in the RD costs obtained from the process in step S51.

In a case where it is determined in step S52 that the RD cost of the FRUC template is the smallest, the process proceeds to step S53. In this case, the FRUC mode is selected as the inter-prediction mode of the current block, and in the image encoding process described with reference to FIG. 7, the encoding process in step S14 is performed to generate an encoded stream.

In step S53, the control unit 21 sets FRUC_flag=1. That is, the control unit 21 sets the value of FRUC_flag serving as the prediction information Pinfo at 1.

In step S54, the control unit 21 generates FRUC_Mode_flag on the basis of a result of deriving the motion information in the FRUC mode, and the inter-prediction processing mode setting process ends.

In a case where the RD cost of the FRUC template obtained when template matching is adopted is smaller when encoding in the FRUC mode than the RD cost of FRUC bilateral when bilateral matching is adopted, the value of FRUC_Mode_flag is set at 0. That is, FRUC_Mode_flag having a value of 0 is generated in step S54. However, when the current block is a P-slice block, the process in step S54 is not performed, or FRUC_Mode_flag is not generated. In contrast, in a case where the RD cost of FRUC bilateral is smaller than the RD cost of the FRUC template (case of step S57), the value of FRUC_Mode_flag is set at 1.

In addition, in a case where it is determined in step S52 that the RD cost of the FRUC template is not the smallest, the process proceeds to step S55. In step S55, the control unit 21 determines whether or not the RD cost of FRUC bilateral is the smallest.

In a case where it is determined in step S55 that the RD cost of the FRUC bilateral is the smallest, the process proceeds to step S56. In this case, the FRUC mode is selected as the inter-prediction mode of the current block, and in the image encoding process described with reference to FIG. 7, the encoding process in step S14 is performed to generate an encoded stream.

In step S56, the control unit 21 sets FRUC_flag=1. That is, the control unit 21 sets the value of FRUC_flag serving as the prediction information Pinfo at 1.

In step S57, the control unit 21 sets FRUC_Mode_flag=1, and the inter-prediction processing mode setting process ends.

Further, in a case where it is determined in step S55 that the RD cost of the FRUC bilateral is not the smallest, the process proceeds to step S58.

In step S58, the control unit 21 sets FRUC_flag=0, and the inter-prediction processing mode setting process ends. Another mode other than the FRUC mode is selected as the inter-prediction mode of the current block, and in the image encoding process described with reference to FIG. 7, the encoding process in step S15 is performed to generate an encoded stream.

As described above, the image encoding device 11 calculates the RD cost of each mode, selects the mode having the smallest RD cost, and generates FRUC_flag in accordance with a result of the selection. This allows the coding efficiency to be increased.

### <Description of FRUC Mode Encoding Process>

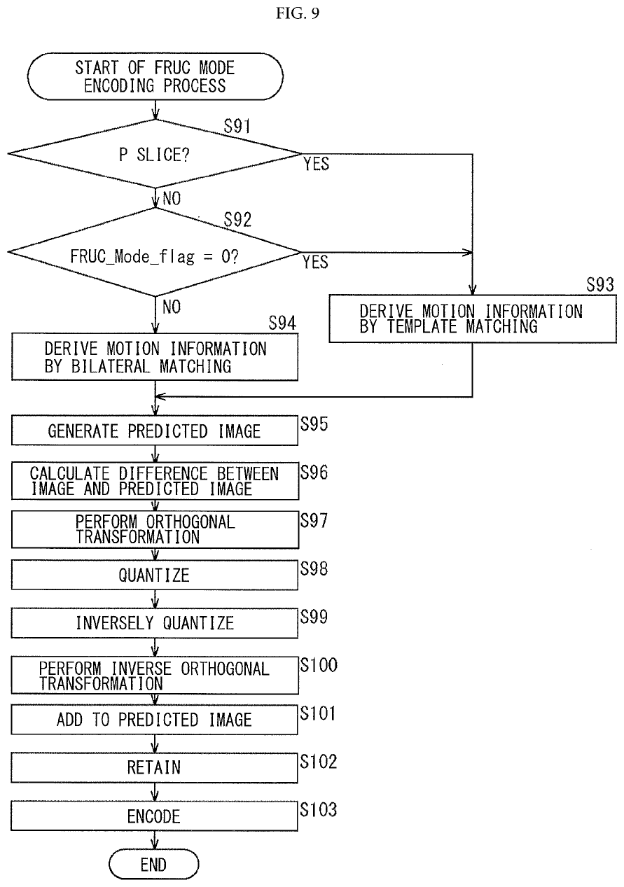

With reference to FIG. 9, an FRUC mode encoding process by the image encoding device 11 is described. It should be noted that this FRUC mode encoding process is a process corresponding to the process in step S14 of FIG. 7, and is performed in units of CUs or subblocks.

In step S91, the prediction unit 30 determines whether or not the current block to be processed, that is, the CU or subblock that is the image I to be encoded is a P-slice block, on the basis of the prediction information Pinfo or the like supplied from the control unit 21.

In a case where it is determined in step S91 that it is not a P-slice block, the process proceeds to step S92.

In step S92, the prediction unit 30 determines whether or not the value of FRUC_Mode_flag set in step S54 or step S57 of FIG. 8 is 0, that is, whether or not FRUC_Mode_flag=0 is satisfied.

In a case where it is determined in step S92 that FRUC_Mode_flag=0 is satisfied, the process proceeds to step S93.

In addition, in a case where it is determined in step S91 that it is a P-slice block, the process proceeds to step S93. In a case where the current block is a P-slice block, there is only one reference picture for the P slice, and bilateral matching is not possible when the motion information is derived. Accordingly, template matching is automatically adopted (selected) as a method of deriving the motion information.

In step S93, the prediction unit 30 derives the motion information of the current block by template matching. The prediction unit 30 reads the picture to be encoded and the reference picture indicated by the reference image specifying information from the frame memory 29 on the basis of the prediction information Pinfo or the like supplied from the control unit 21. The prediction unit 30 uses the read picture to derive the motion information of the current block by template matching.

The process in step S93 is performed to derive the motion information, and the process then proceeds to step S95.

In contrast, in a case where it is determined in step S92 that FRUC_Mode_flag=1 is satisfied, the process proceeds to step S94.

In step S94, the prediction unit 30 derives the motion information of the current block by bilateral matching.

For example, the prediction unit 30 reads, from the frame memory 29, two reference pictures indicated by the reference image specifying information of the prediction information Pinfo supplied from the control unit 21. In addition, the prediction unit 30 uses the read reference pictures to derive the motion information of the current block by bilateral matching.

After the process in step S94 or step S93 is performed, the process in step S95 is performed. In step S95, the prediction unit 30 generates a predicted image on the basis of the motion information derived by bilateral matching or on the basis of the motion information derived by template matching, and supplies the calculation unit 22 and the calculation unit 28.

In a case of bilateral matching, the prediction unit 30 uses, as the predicted image P, an image generated from motion compensation in which each block is used that is indicated by a motion vector that is the motion information in each of the two reference pictures. In a case of template matching, the prediction unit 30 uses, as the predicted image P, an image of a block indicated by a motion vector that is the motion information in the reference picture.

After the process in step S95 is performed and the predicted image P is generated, the process in step S96 is performed.

In step S96, the calculation unit 22 calculates the difference between the supplied image I and the predicted image P supplied from the prediction unit 30 as a prediction residual D and supplies the transformation unit 23.

In step S97, the transformation unit 23 performs orthogonal transformation and the like on the prediction residual D supplied from the calculation unit 22 on the basis of the transformation information Tinfo supplied from the control unit 21, and derives the resulting transformation coefficient Coeff to the quantization unit 24.

In step S98, on the basis of the transformation information Tinfo supplied from the control unit 21, the quantization unit 24 scales (quantizes) the transformation coefficient Coeff supplied from the transformation unit 23, and derives a quantization transformation coefficient level level. The quantization unit 24 supplies the quantization transformation coefficient level level to the encoding unit 25 and the inverse quantization unit 26.

In step S99, on the basis of the transformation information Tinfo supplied from the control unit 21, the inverse quantization unit 26 inversely quantizes the quantization transformation coefficient level level supplied from the quantization unit 24, with a characteristic corresponding to a characteristic of the quantization in step S98. The inverse quantization unit 26 supplies the inverse transformation unit 27 with the transformation coefficient Coeff IQ obtained as a result of the inverse quantization.

In step S100, on the basis of the transformation information Tinfo supplied from the control unit 21, the inverse transformation unit 27 performs inverse orthogonal transformation or the like on the transformation coefficient Coeff IQ supplied from the inverse quantization unit 26 in a method corresponding to the orthogonal transformation or the like in step S97. The prediction residual D′ is derived by inverse orthogonal transformation. The inverse transformation unit 27 supplies the acquired prediction residual D′ to the calculation unit 28.

In step S101, the calculation unit 28 generates a local decoded image Rec by adding the prediction residual D′ supplied from the inverse transformation unit 27 and the predicted image P supplied from the prediction unit 30, and supplies the frame memory 29.

In step S102, the frame memory 29 reconstructs the decoded image in picture units by using the local decoded image Rec supplied from the calculation unit 28, and retains the reconstructed image in the buffer in the frame memory 29.

In step S103, the encoding unit 25 encodes, in a predetermined method, the encoding parameter that is set in the process in step S11 of FIG. 7 and supplied from the control unit 21, and the quantization transformation coefficient level level that is supplied from the quantization unit 24 in the process in step S98.

The encoding unit 25 multiplexes the encoded data obtained by the encoding into an encoded stream (bit stream), and outputs it to the outside of the image encoding device 11, and the FRUC mode encoding process ends.

In this case, the encoded stream stores, for example, data obtained by encoding FRUC_flag, FRUC_Mode_flag, reference image specifying information, and the like, data obtained by encoding the quantization transformation coefficient level level, and the like. The encoded stream obtained in this manner is transmitted to a decoding side via a transmission path or a recording medium, for example.

As described above, the image encoding device 11 derives the motion information in the FRUC mode, and encodes a block to be encoded. In this manner, using the FRUC mode and deriving the motion information on the decoding side make it possible to reduce the motion vector information (motion information) stored in the encoded stream, allowing the coding efficiency to be increased.

### <Description of Motion Information Derivation Process by Template Matching>

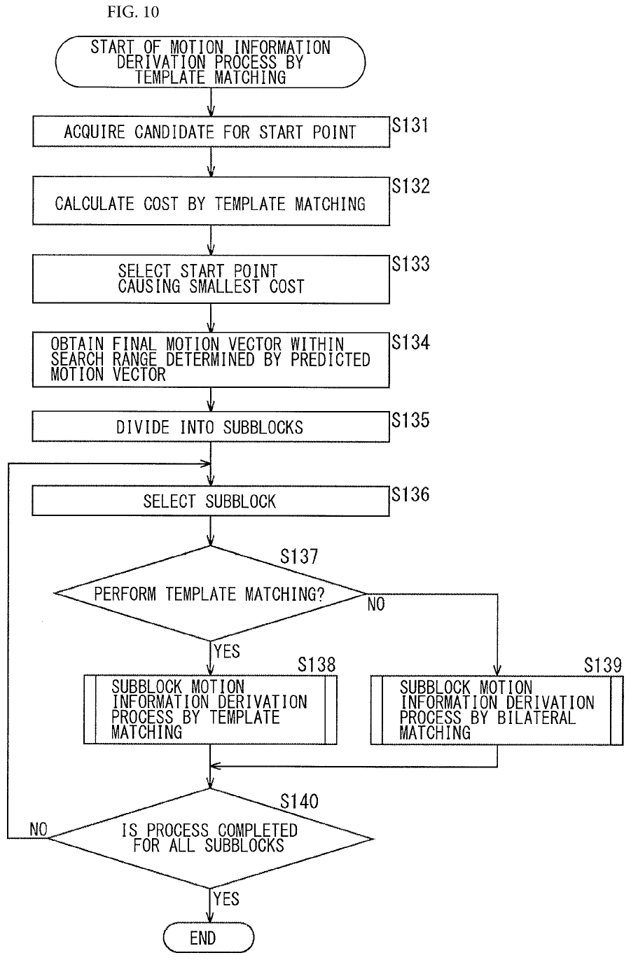

Here, the process of deriving the motion information in the process corresponding to step S93 and step S94 of FIG. 9 is described in more detail. First, a process in a case where the motion information of CU to be processed is derived by template matching is described. That is, the following describes the motion information derivation process performed by the prediction unit 30 by template matching with reference to the flowchart of FIG. 10. It should be noted that this process is performed by the template matching processor 52 under the control of the prediction controller 51.

In step S131, the candidate acquisition section 61 of the template matching processor 52 generates a candidate list by obtaining a candidate for the start point.

That is, the candidate acquisition section 61 collects the surrounding region as a candidate for the start point, and generates a candidate list. In addition, the candidate acquisition section 61 acquires an adjacent motion vector to the reference picture of the surrounding region indicated by the candidate list, and supplies the motion vector derivation section 62.

In step S132, the motion vector derivation section 62 calculates the cost of the start point of CU to be encoded by template matching for each start point for each reference picture with the adjacent motion vector used as the start point. In this case, template matching is performed by using a picture to be encoded and a reference picture that are decoded images read from the frame memory 29.

In step S133, the motion vector derivation section 62 selects, as the predicted motion vector, the candidate start point causing the smallest cost from the candidates for the respective start points in step S132.

In step S134, the motion vector derivation section 62 determines the search range on the reference picture determined by the selected start point, that is, the predicted motion vector. The motion vector derivation section 62 obtains the final motion vector by template matching while moving the position of the template within the obtained search range.

The motion vector derivation section 62 supplies the derived final motion vector to the candidate acquisition section 61 of the template matching processor 52.

In step S135, the prediction controller 51 divides CU to be encoded into subblocks. For example, on the basis of split flag of the prediction information Pinfo from the control unit 21, CU is divided into 16 subblocks. In step S136, the prediction controller 51 selects one subblock.

In step S137, the prediction controller 51 determines whether or not to perform template matching to derive the predicted motion vector of the selected subblock, on the basis of the position of the subblock in the CU to be encoded.

For example, as described with reference to FIG. 5, in a case where the position of the subblock in the CU to be encoded is the uppermost or the leftmost portion of the CU to be encoded, template matching is performed in step S137, and thus the process proceeds to step S138.

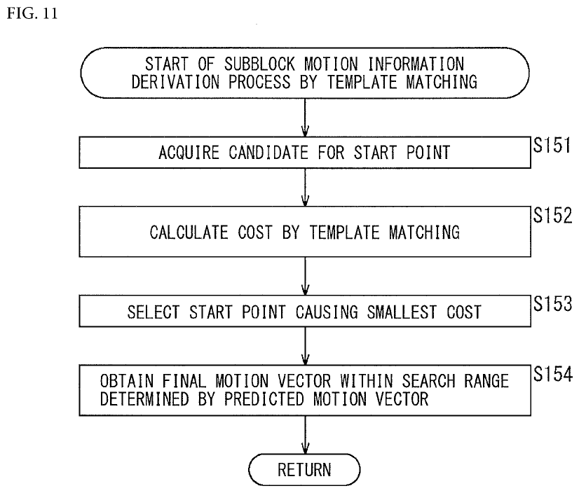

In step S138, the template matching processor 52 performs a subblock motion information derivation process by template matching. This subblock motion information derivation process by template matching is described below with reference to the flowchart of FIG. 11. In this process, the motion information of the subblock selected in step S136 is derived by template matching.

In contrast, in a case where the position of the subblock in the CU to be encoded is a position other than the uppermost and leftmost portions of the CU to be encoded, the prediction controller 51 determines in step S137 that bilateral matching is performed, and the process proceeds to step S139.

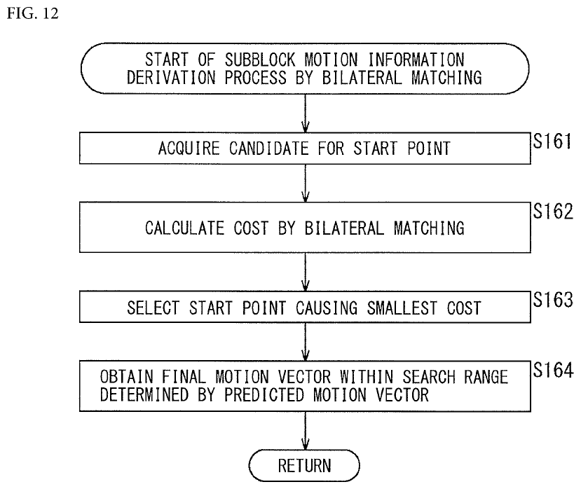

In step S139, the bilateral matching processor 53 performs a subblock motion information derivation process by bilateral matching. This subblock motion information derivation process by bilateral matching is described below with reference to the flowchart of FIG. 12. In this process, the motion information of the subblock selected in step S136 is derived by bilateral matching.

Once the motion information of the subblock is derived in step S138 or step S139, the process proceeds to step S140.

In step S140, the prediction controller 51 determines whether or not the process is completed for all the subblocks of CU to be encoded. In a case where it is determined in step S140 that the process for all the subblocks of CU to be encoded has not yet been completed, the process returns to step S136, and the subsequent processes are repeated.

In a case where it is determined in step S140 that the process for all the subblocks of CU to be encoded is completed, the motion information derivation process by template matching ends.

As described above, in the image encoding device 11, motion information is derived in the bilateral mode in accordance with the position of a subblock in CU for which motion information is derived by using template matching. This allows the derivation accuracy of the motion information of a subblock having no template to be improved.

Next, with reference to the flowchart of FIG. 11, the subblock motion information derivation process by template matching in step S138 of FIG. 10 is described.

In step S151, the candidate acquisition section 61 of the template matching processor 52 generates a subblock candidate list by obtaining a candidate for the start point.

That is, the candidate acquisition section 61 generates not only a list of surrounding regions predefined for the subblock to be processed, but also a subblock candidate list also including, as one candidate, the motion vector obtained for the CU including the subblock. In addition, the candidate acquisition section 61 acquires the adjacent motion vector to the reference picture of the surrounding region indicated by the subblock candidate list and the motion vector obtained for CU, and supplies the motion vector derivation section 62.

In step S152, the motion vector derivation section 62 calculates the cost for the start point of a subblock by template matching for each start point for each reference picture with the adjacent motion vector used as the start point. In this case, template matching is performed by using a picture to be encoded and a reference picture that are decoded images read from the frame memory 29.

In step S153, the motion vector derivation section 62 selects, as the predicted motion vector, the candidate start point causing the smallest cost from the candidates for the respective start points in step S152.

In step S154, the motion vector derivation section 62 obtains the search range on the reference picture determined by the selected predicted motion vector, and obtains the final motion vector by template matching while moving the position of the template within the obtained search range.

Next, with reference to the flowchart of FIG. 12, the subblock motion information derivation process by bilateral matching in step S139 of FIG. 10 is described.

In step S161, the candidate acquisition section 71 of the bilateral matching processor 53 generates a subblock candidate list by obtaining a candidate for the start point.

That is, the candidate acquisition section 71 generates not only a list of surrounding regions predefined for the subblock to be processed, but also a subblock candidate list also including, as one candidate, the motion vector obtained for the CU including the subblock. In addition, the candidate acquisition section 71 acquires the adjacent motion vector to the reference picture of the surrounding region indicated by the subblock candidate list and the motion vector obtained for CU, and supplies the motion vector derivation section 72.

In step S162, the motion vector derivation section 72 calculates, by bilateral matching, the difference between the difference calculation blocks determined by respective candidates for the start points in two reference pictures for each candidate for the start point. The motion vector derivation section 72 calculates the cost obtained from a result of the calculation of the difference. In this case, bilateral matching is performed by using reference pictures that are decoded images read from the frame memory 29 and are different from each other in time.

In step S163, the motion vector derivation section 72 selects, as the predicted motion vector, the candidate start point causing the smallest cost from the candidates for the respective start points in step S162.

In step S164, the motion vector derivation section 72 obtains the search range on the reference picture determined by the selected predicted motion vector. The motion vector derivation section 72 obtains the final motion vector by bilateral matching while moving the position of the difference calculation block within the obtained search range.

As described above, the prediction unit 30 derives the motion information of a subblock by template matching or bilateral matching in accordance with the position of the subblock in CU.

### <Description of Motion Information Derivation Process by Bilateral Matching>

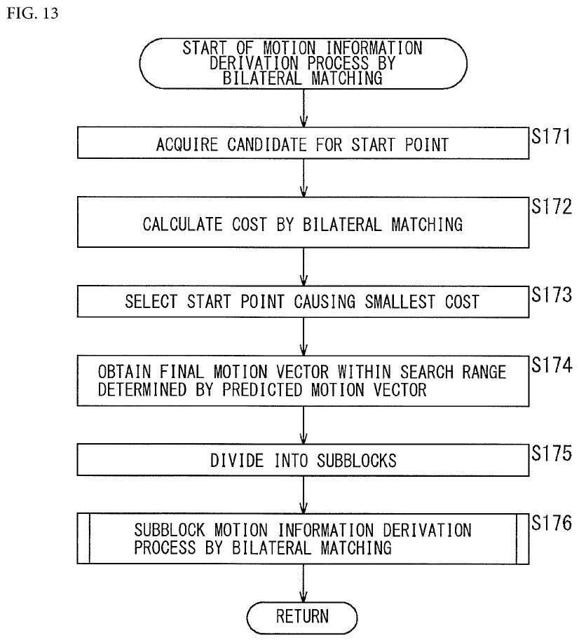

In addition, a process in a case where the motion information of CU to be processed is derived by bilateral matching is described. That is, the following describes the motion information derivation process performed by the prediction unit 30 by bilateral matching with reference to the flowchart of FIG. 13.

In step S171, the candidate acquisition section 71 of the bilateral matching processor 53 generates a candidate list by obtaining a candidate for the start point.

That is, the candidate acquisition section 71 collects the surrounding region as a candidate for the start point, and generates a candidate list. In addition, the candidate acquisition section 71 acquires an adjacent motion vector to the reference picture of the surrounding region indicated by the candidate list, and supplies the motion vector derivation section 72.

In step S172, the motion vector derivation section 72 calculates, by bilateral matching, the difference between the difference calculation blocks determined by respective candidates for the start points in two reference pictures for each candidate for the start point. The motion vector derivation section 72 calculates the cost obtained from a result of the calculation of the difference. In this case, bilateral matching is performed by using reference pictures that are decoded images read from the frame memory 29 and different from each other in time.

In step S173, the motion vector derivation section 72 selects, as a predicted motion vector, the candidate start point for which the cost obtained in step S172 is the smallest from among candidates for the respective start points.

In step S174, the motion vector derivation section 72 obtains the search range on the reference picture determined by the selected predicted motion vector. The motion vector derivation section 72 obtains the final motion vector by bilateral matching while moving the position of the difference calculation block within the obtained search range.

The motion vector derivation section 72 supplies the final motion vector obtained by the selection to the candidate acquisition section 71.

In step S175, the prediction controller 51 divides CU to be encoded into subblocks. For example, CU to be encoded is divided into 16 subblocks.

In step S176, the bilateral matching processor 53 performs the subblock motion information derivation process by bilateral matching. In this subblock motion information derivation process by bilateral matching, a process that is basically similar to the process described above with reference to FIG. 12 is performed, and the description thereof is thus omitted. The process in step S176 derives the motion information for a subblock.

As described above, the prediction unit 30 derives the motion information by bilateral matching.

### <Description of Image Decoding Device>

Next, an image decoding device serving as the image processing device to which the present technology is applied for decoding an encoded stream outputted from the image encoding device 11 illustrated in FIG. 1 is described.

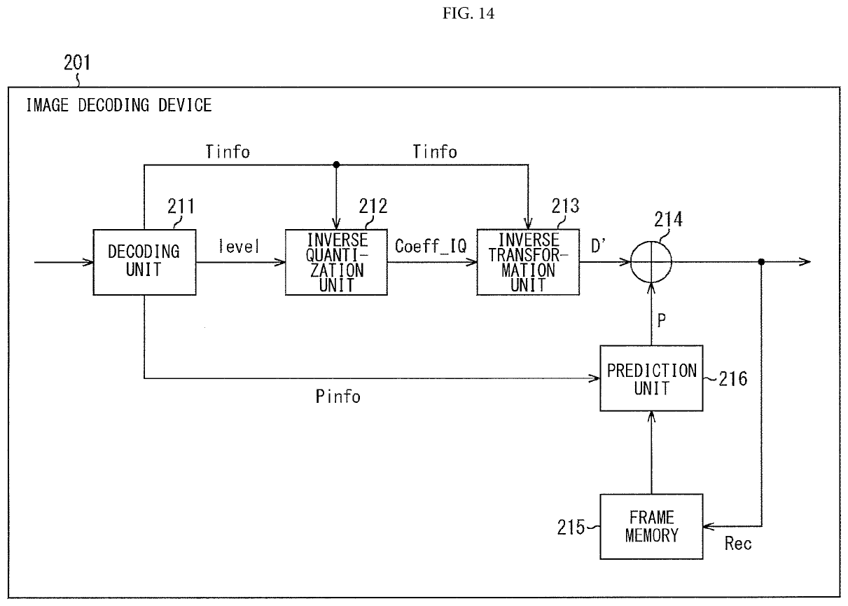

FIG. 14 is a diagram illustrating a configuration example of an image decoding device according to an embodiment to which the present technology is applied.

An image decoding device 201 of FIG. 14 decodes the encoded stream generated by the image encoding device 11 in a decoding method corresponding to an encoding method in the image encoding device 11. For example, the image decoding device 201 implements the technology proposed to HEVC or the technology proposed in JVET.

It should be noted that FIG. 14 mainly illustrates a processing unit, the flow of data, and the like, but FIG. 14 does not necessarily illustrate everything. That is, the image decoding device 201 may include a processing unit that is not illustrated as a block in FIG. 14, or there may be flows of processes and data that are not indicated by arrows or the like in FIG. 14.

The image decoding device 201 includes a decoding unit 211, an inverse quantization unit 212, an inverse transformation unit 213, a calculation unit 214, a frame memory 215, and a prediction unit 216.

The image decoding device 201 decodes an inputted encoded stream for each CU or for each subblock.

The decoding unit 211 decodes the supplied encoded stream in a predetermined decoding method corresponding to the encoded method in the encoding unit 25. For example, the decoding unit 211 decodes the encoding parameters of the header information Hinfo, the prediction information Pinfo, the transformation information Tinfo, and the like, and the quantization transformation coefficient level level from a bit string of the encoded stream in accordance with the definition of the syntax table.

For example, the decoding unit 211 divides CU on the basis of split flag included in the encoding parameters, and sequentially sets CUs or subblocks corresponding to the respective quantization transformation coefficient levels level as blocks to be decoded.

In addition, the decoding unit 211 supplies an encoding parameter obtained from the decoding to each block of the image decoding device 201. For example, the decoding unit 211 supplies the prediction information Pinfo to the prediction unit 216, supplies the transformation information Tinfo to the inverse quantization unit 212 and the inverse transformation unit 213, and supplies the header information Hinfo to each block. In addition, the decoding unit 211 supplies the quantization transformation coefficient level level to the inverse quantization unit 212.

On the basis of the transformation information Tinfo supplied from the decoding unit 211, the inverse quantization unit 212 scales (inversely quantizes) the value of the quantization transformation coefficient level level supplied from the decoding unit 211, and derives the transformation coefficient Coeff IQ. This inverse quantization is an inverse process of the quantization performed by the quantization unit 24 of the image encoding device 11. It should be noted that the inverse quantization unit 26 performs an inverse quantization similar to that of this inverse quantization unit 212. The inverse quantization unit 212 supplies the acquired transformation coefficient Coeff IQ to the inverse transformation unit 213.

The inverse transformation unit 213 performs inverse orthogonal transformation or the like on the transformation coefficient Coeff IQ supplied from the inverse quantization unit 212 on the basis of the transformation information Tinfo and the like supplied from the decoding unit 211, and derives the resulting prediction residual D′ to the calculation unit 214.

The inverse orthogonal transformation performed in the inverse transformation unit 213 is the inverse process of the orthogonal transformation performed by the transformation unit 23 of the image encoding device 11. It should be noted that this inverse transformation unit 27 performs inverse orthogonal transformation similar to that of this inverse transformation unit 213.

The calculation unit 214 adds the prediction residual D′ supplied from the inverse transformation unit 213 and the predicted image P corresponding to the prediction residual D′ together, and derives the local decoded image Rec.

The calculation unit 214 reconstructs the decoded image for each picture unit by using the acquired local decoded image Rec, and outputs the acquired decoded image to the outside. In addition, the calculation unit 214 also supplies the local decoded image Rec to the frame memory 215.

The frame memory 215 reconstructs the decoded image for each picture unit by using the local decoded image Rec supplied from the calculation unit 214, and stores the reconstructed image in the buffer in the frame memory 215.

In addition, the frame memory 215 reads out the decoded image designated by the prediction unit 216 from the buffer as a reference image (reference picture), and supplies the prediction unit 216. Further, the frame memory 215 may store the header information Hinfo, the prediction information Pinfo, the transformation information Tinfo, and the like for the generation of the decoded image in the buffer in the frame memory 215.

On the basis of the mode information pred_mode_flag of the prediction information Pinfo, the prediction unit 216 acquires, as a reference image, the decoded image at the same time as that of the block to be encoded stored in the frame memory 215. Then, using the reference image, the prediction unit 216 performs, on the block to be decoded, an intra-prediction process in the intra-prediction mode indicated by the intra-prediction mode information.

On the basis of the mode information pred_mode_flag of the prediction information Pinfo and the reference image specifying information, the prediction unit 216 acquires, as a reference image, the decoded image at the same time as that of the block to be decoded stored in the frame memory 215. In addition, the prediction unit 216 acquires a decoded image different from the block to be decoded in time as a reference image.

The prediction unit 216 performs an inter-prediction process in the mode determined by FRUC_flag by using the image acquired from the frame memory 215, on the basis of FRUC_flag, FRUC_Mode_flag, the motion information, and the like, similarly to the prediction unit 30 of the image encoding device 11.

The prediction unit 216 supplies the predicted image P of the block to be decoded that is generated as a result of the intra-prediction process or the inter-prediction process to the calculation unit 214.

### <Regarding Components of Prediction Unit>

In addition, the prediction unit 216 of the image decoding device 201 also includes a component that derives the motion information by template matching or bilateral matching as in the prediction unit 30 of the image encoding device 11.

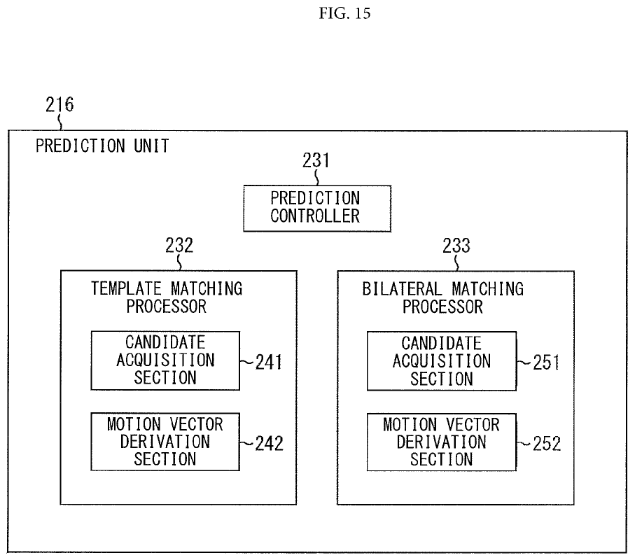

For example, the prediction unit 216 includes a component illustrated in FIG. 15 as a component that derives motion information by template matching or bilateral matching.

That is, in the example illustrated in FIG. 15, the prediction unit 216 includes a prediction controller 231, a template matching processor 232, and a bilateral matching processor 233.

In addition, the template matching processor 232 includes a candidate acquisition section 241 and a motion vector derivation section 242, and the bilateral matching processor 233 includes a candidate acquisition section 251 and a motion vector derivation section 252.

It should be noted that the prediction controller 231 to the bilateral matching processor 233 correspond to the prediction controller 51 to the bilateral matching processor 53 illustrated in FIG. 6, and have configurations similar to those of the prediction controller 51 to the bilateral matching processor 53. In addition, the prediction controller 231 to the bilateral matching processor 233 perform operations similar to those of the prediction controller 51 to the bilateral matching processor 53, and the description thereof is thus omitted.

The candidate acquisition section 241 and the motion vector derivation section 242 also have configurations similar to those of the candidate acquisition section 61 and the motion vector derivation section 62 illustrated in FIG. 6 and perform similar operations, and the description thereof is thus omitted. The candidate acquisition section 251 and the motion vector derivation section 252 also have configurations similar to those of the candidate acquisition section 71 and the motion vector derivation section 72 illustrated in FIG. 6 and perform similar operations, and the description thereof is thus omitted.

### <Description of Image Decoding Process>

Next, the operation of the image decoding device 201 is described.

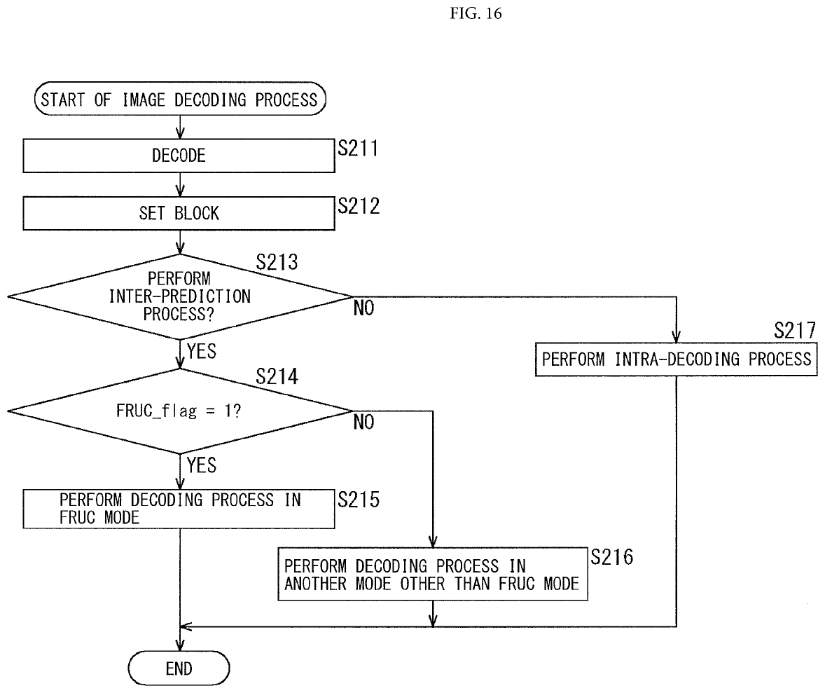

First, with reference to the flowchart of FIG. 16, the image decoding process by the image decoding device 201 is described.

In step S211, the decoding unit 211 decodes the encoded stream supplied to the image decoding device 201 to obtain the encoding parameter and the quantization transformation coefficient level level.

The decoding unit 211 supplies the encoding parameter to each unit of the image decoding device 201 and supplies the quantization transformation coefficient level level to the inverse quantization unit 212.

In step S212, the decoding unit 211 divides CTU on the basis of split flag included in the encoding parameters, and sets the block, that is, CU or subblock corresponding to each quantization transformation coefficient level level as the block to be decoded. It should be noted that the following processes in step S213 to step S217 are performed for each block to be decoded.

After the block to be decoded is determined, the processes in step S213 and step S214 are performed by the prediction unit 216 on the basis of the prediction information Pinfo outputted from the decoding unit 211, and the mode at the time of decoding is determined. It should be noted that the processes in step S213 and step S214 are similar to the processes in step S12 and step S13 of FIG. 7 except that they are performed by the prediction unit 216 instead of the prediction unit 30, and the description thereof is thus omitted.

In a case where it is determined in step S214 that FRUC_flag=1 is satisfied, that is, in a case where it is determined that it is the FRUC mode, the process proceeds to step S215.

In step S215, each unit of the image decoding device 201 performs a decoding process of decoding the image of the block (current block) to be decoded in the FRUC mode, and the image decoding process ends.

In the decoding process in the FRUC mode, the motion information is derived in the FRUC mode, and the image of the block to be decoded is generated by using the predicted image P generated by performing an inter-prediction process using the obtained motion information.

In contrast, in a case where it is determined in step S214 that FRUC_flag=1 is not satisfied, that is, in a case where it is determined that FRUC_flag=0 is satisfied and it is not the FRUC mode, the process proceeds to step S216.

In step S216, each unit of the image decoding device 201 performs a decoding process of decoding the image of the block to be decoded in another mode, for example, such as the AMVP mode other than the FRUC mode, and the image decoding process ends.

In addition, in a case where it is determined in step S213 that no inter-prediction process is performed, that is, in a case where it is determined that an intra-prediction process is performed, the process proceeds to step S217.

In step S217, each unit of the image decoding device 201 performs an intra-decoding process of decoding the image of the block to be decoded in the intra-prediction mode, and the image decoding process ends.

In the intra-decoding process, the predicted image P is generated in the intra-prediction mode in the prediction unit 216, and the predicted image P and the prediction residual D′ are added to form the image of the block to be decoded.

As described above, the image decoding device 201 decodes the block to be decoded in accordance with an encoding parameter. Decoding the image in such an appropriate mode allows an image having high quality to be acquired even with an encoded stream having a small code amount.

### <Description of FRUC Mode Decoding Process>

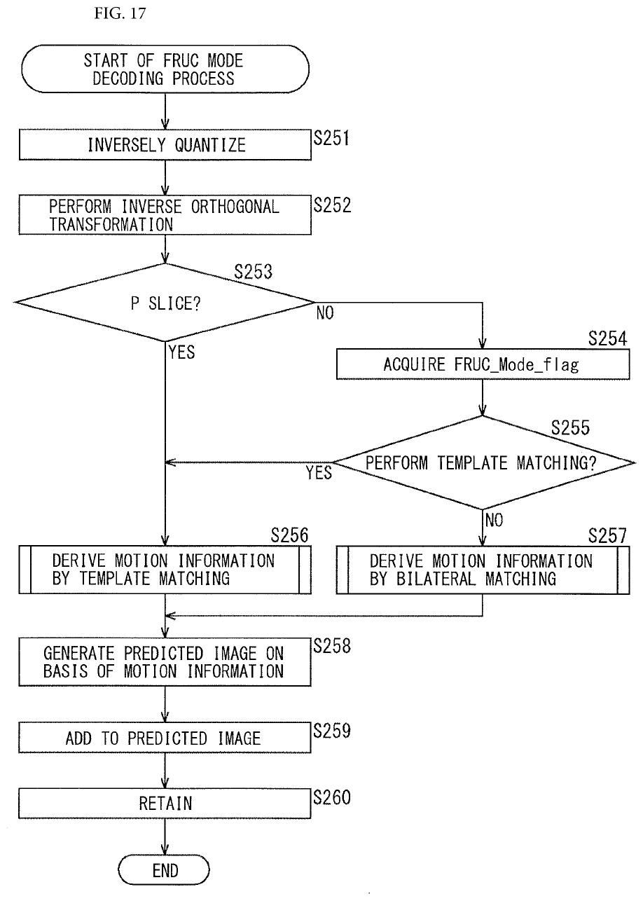

Next, an FRUC mode decoding process corresponding to the process in step S215 of FIG. 16 is described. That is, the following describes the FRUC mode decoding process performed by the image decoding device 201 with reference to the flowchart of FIG. 17. It should be noted that this FRUC mode decoding process is performed for each block to be decoded.

In step S251, the inverse quantization unit 212 inversely quantizes the quantization transformation coefficient level level obtained by the process in step S211 of FIG. 16 to derive the transformation coefficient Coeff IQ, and supplies the inverse transformation unit 213.

In step S252, the inverse transformation unit 213 performs inverse orthogonal transformation or the like on the transform coefficient Coeff IQ supplied from the inverse quantization unit 212, and supplies the resulting prediction residual D′ to the calculation unit 214.

In step S253, the prediction unit 216 determines whether or not the block to be decoded is a P-slice block, on the basis of the prediction information Pinfo or the like supplied from the decoding unit 211.

In a case where it is determined in step S253 that it is not a P-slice block, the process proceeds to step S254.

In step S254, the prediction unit 216 acquires FRUC_Mode_flag.

That is, in a case where the block to be decoded is not a P-slice block, FRUC_Mode_flag is read from the encoded stream by the decoding unit 211 in step S211 of FIG. 16. The prediction information Pinfo including read FRUC_Mode_flag is supplied from the decoding unit 211 to the prediction unit 216. The prediction unit 216 acquires FRUC_Mode_flag from the prediction information Pinfo supplied in this manner.

In step S255, the prediction unit 216 determines whether or not to perform template matching, on the basis of FRUC_Mode_flag. For example, in a case where the value of FRUC_Mode_flag is 0, it is determined that template matching is performed.

In a case where it is determined in step S255 that template matching is performed, or in a case where it is determined in step S253 that it is a P-slice block, the process in step S256 is performed.

In step S256, the prediction unit 216 derives the motion information by template matching. This offers a motion vector as the motion information of the block to be decoded.

In contrast, in a case where it is determined in step S255 that template matching is not performed, the process in step S257 is performed.

In step S257, the prediction unit 216 derives the motion information by bilateral matching. This offers a motion vector as the motion information of the block to be decoded.

After the process in step S256 or step S257 is performed, the process in step S258 is performed. In step S258, the prediction unit 216 performs motion compensation on the basis of the motion information, that is, the motion vector derived by the process in step S256 or step S257 to generate the predicted image P, and supplies the calculation unit 214.

In a case where the motion information is derived by template matching, the prediction unit 216 reads one decoded image indicated by the reference image specifying information from the frame memory 215 as the reference picture. In addition, the prediction unit 216 uses the image of the block indicated by the motion vector in the read reference picture as the predicted image P.

In a case where the motion information is derived by bilateral matching, the prediction unit 216 reads two decoded images indicated by the reference image specifying information from the frame memory 215 as the reference pictures. In addition, the prediction unit 216 generates the predicted image P by motion compensation using the block indicated by the motion vector in each read reference picture.

After the predicted image P is obtained in this manner, the process proceeds to step S259.

In step S259, the calculation unit 214 adds the prediction residual D′ supplied from the inverse transformation unit 213 and the predicted image P supplied from the prediction unit 216 together, and derives the local decoded image Rec. The calculation unit 214 reconstructs the decoded image for each picture unit by using the acquired local decoded image Rec, and outputs the acquired decoded image to the outside of the image decoding device 201. Further, the calculation unit 214 supplies the local decoded image Rec to the frame memory 215.

In step S260, the frame memory 215 reconstructs the decoded image in picture units by using the local decoded image Rec supplied from the calculation unit 214, and retains the decoded image in the buffer in the frame memory 215. Once the decoded image is obtained in this manner, the FRUC mode decoding process ends.

As described above, the image decoding device 201 derives the motion information in the FRUC mode, and decodes a block to be decoded. In this manner, using the FRUC mode and deriving the motion information on the decoding side allow the code amount of the encoded stream to be reduced and allow the coding efficiency to be increased.

### <Description of Motion Information Derivation Process by Template Matching>

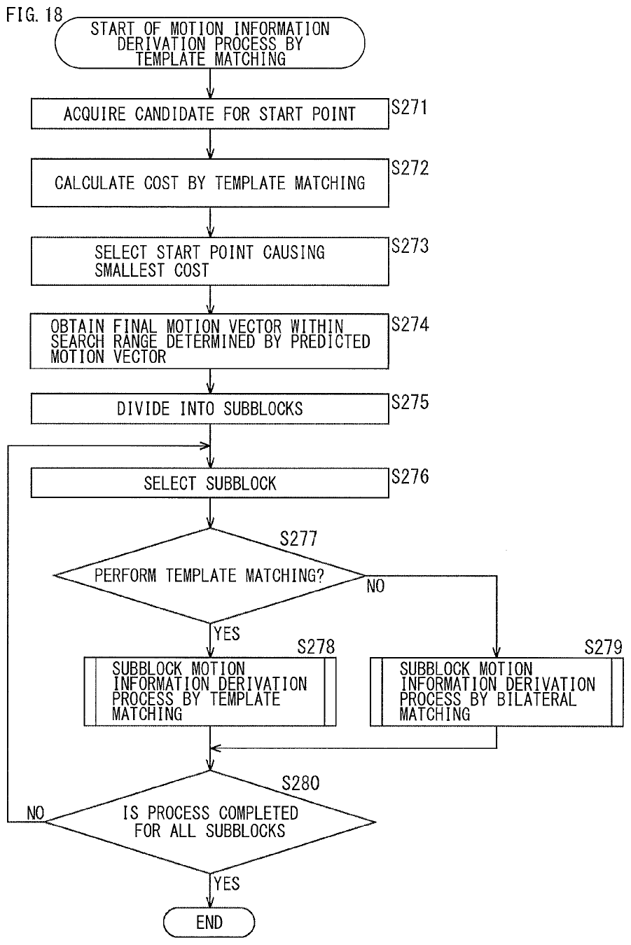

In addition, with reference to the flowchart of FIG. 18, the motion information derivation process by template matching corresponding to the process in step S256 of FIG. 17 that is performed by the prediction unit 216 is described.

In the motion information derivation process by template matching, the process in step S271 is performed by the candidate acquisition section 241, and the processes in step S272 to step S274 are performed by the motion vector derivation section 242.

In a case where the processes in step S275 to step S277 are performed by the prediction controller 231, and it is determined in step S277 that template matching is performed, the process in step S278 is performed by the template matching processor 232. In addition, in a case where it is determined in step S277 that template matching is not performed, the process in step S279 is performed by the bilateral matching processor 233.

Further, after the process in step S278 or step S279 is performed, the process in step S280 is performed by the prediction controller 231, and the motion information derivation process by template matching ends.

It should be noted that these processes in step S271 to step S280 are similar to the processes in step S131 to step S140 in FIG. 10, and the description thereof is thus omitted.

As described above, even in the image decoding device 201, the motion information is derived in the bilateral mode in accordance with the position of a subblock in CU, and it is thus possible to improve the derivation accuracy of the motion information of a subblock having no template.

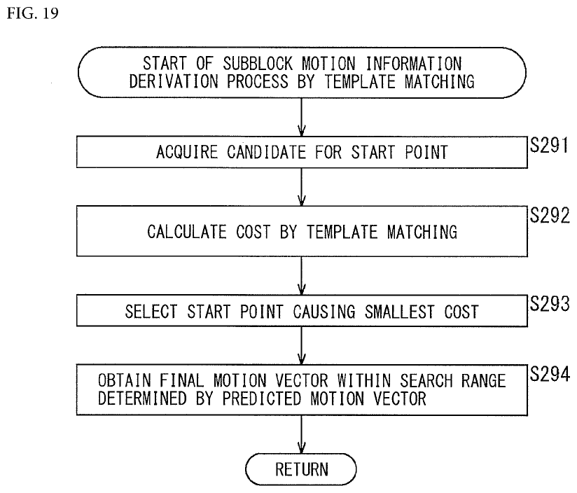

Next, with reference to the flowchart of FIG. 19, the subblock motion information derivation process by template matching in step S278 of FIG. 18 is described.

In the subblock motion information derivation process by template matching, the process in step S291 is performed by the candidate acquisition section 241, and the processes in step S292 to step S294 are performed by the motion vector derivation section 242.

It should be noted that these processes in step S291 to step S294 are similar to the processes in step S151 to step S154 in FIG. 11, and the description thereof is thus omitted.

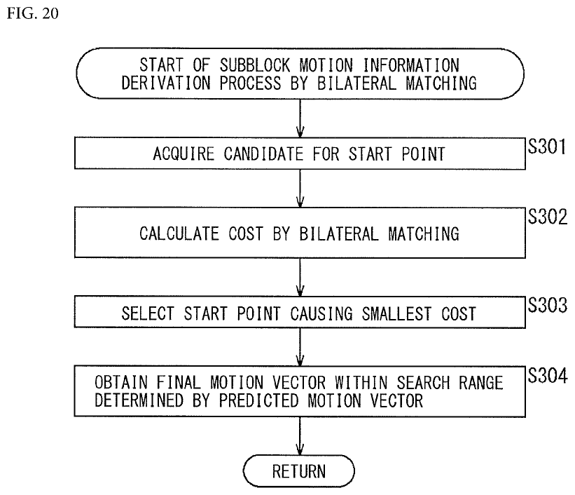

Next, with reference to the flowchart of FIG. 20, the subblock motion information derivation process by bilateral matching in step S279 of FIG. 18 is described.

In the subblock motion information derivation process by bilateral matching, the process in step S301 is performed by the candidate acquisition section 251, and the processes in step S302 to step S304 are performed by the motion vector derivation section 252.

It should be noted that these processes in step S301 to step S304 are similar to the processes in step S161 to step S164 in FIG. 12, and the description thereof is thus omitted.

### <Description of Motion Information Derivation Process by Bilateral Matching>

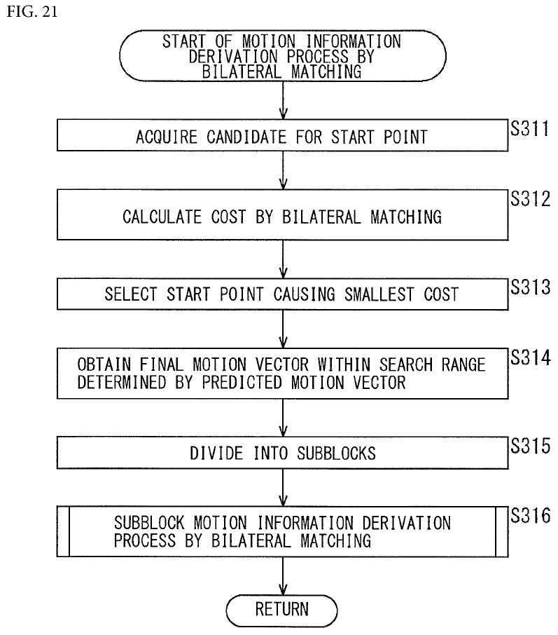

Here, with reference to the flowchart of FIG. 21, the motion information derivation process by bilateral matching corresponding to the process in step S257 of FIG. 17 that is performed by the prediction unit 216 is described.

In the motion information derivation process by bilateral matching, the process in step S311 is performed by the candidate acquisition section 251, and the processes in step S312 to step S314 are performed by the motion vector derivation section 252.

In addition, the process in step S315 is performed by the prediction controller 231, and the process in step S316 is performed by the bilateral matching processor 233.

It should be noted that these processes in step S311 to step S316 are similar to the processes in step S171 to step S176 in FIG. 13, and the description thereof is thus omitted.

### Second Embodiment

### <Size of Subblocks in Template Matching>

As described above with reference to FIG. 5, when the motion information of CU is derived by template matching, the derivation accuracy of the motion vector is lowered because there is a subblock having no template for which it is not possible to perform template matching.

To address this, in the first embodiment, an example has been described in which not only template matching, but also bilateral matching are used for a subblock in accordance with the position of the subblock in CU.

However, with reference to FIG. 5 again, the region STM11-1 and the region STM11-2 are much smaller in size than the region TM11-1 and the region TM11-2. The region TM11-1 and the region TM11-2 are regions that are adjacent to the current block CB11 and used for template matching. The region STM11-1 and the region STM11-2 are regions that are adjacent to the subblock SCB11-1 and used for the template matching of the subblock SCB11-1.

In this manner, when the motion information of CU is derived by template matching, a result of template matching for a subblock becomes uncertain because a template is small in size.

This is because block matching between frames performed by using most of the image limits image matching positions (i.e., MVs) while using only local portions of an image increases the possibility of finding similar images at a plurality of positions.

Accordingly, in a second embodiment of the present technology, the size of a subblock is changed in accordance with the block matching used in CU, and the motion information of the subblock is derived by using the block matching used in the CU.

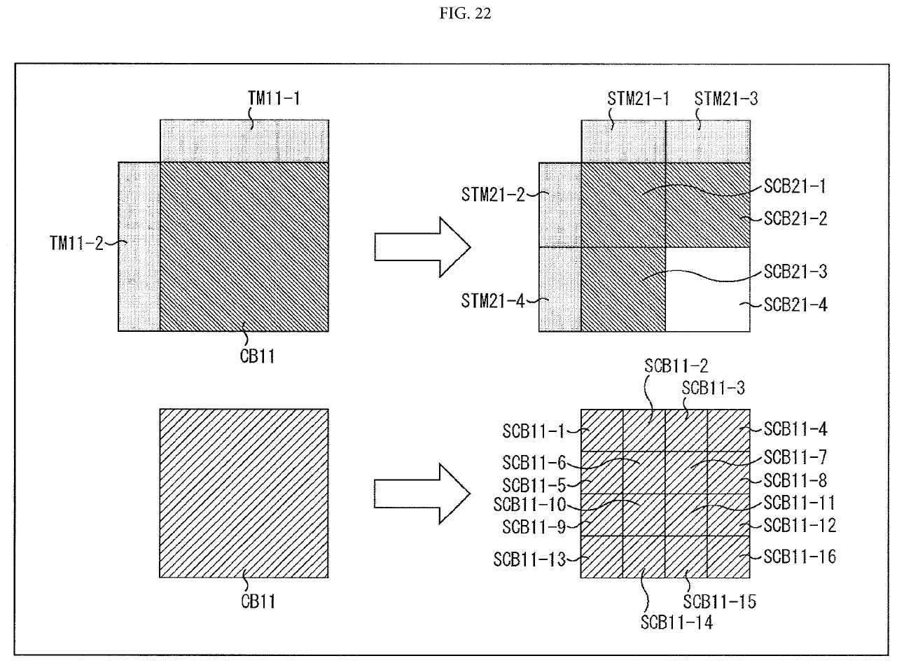

FIG. 22 is a diagram describing the influence of the size of subblocks in template matching.

In the upper portion of FIG. 22, template matching is used to derive the motion information of the current block CB11, and the current block CB11 is divided into four subblocks SCB21-1 to SCB21-4. It should be noted that, in FIG. 22, portions corresponding to those in the case in FIG. 4 are denoted with the same reference numerals, and the description thereof is omitted as appropriate.

The subblock SCB21-1 is positioned on the upper left of the current block CB11. The subblock SCB21-1 has a region STM21-1 and a region STM21-2 adjacent to the subblock SCB21-1. The region STM21-1 and the region STM21-2 serve as templates. The subblock SCB21-2 is positioned on the upper right of the current block CB11. The subblock SCB21-2 has a region STM21-3 adjacent to the subblock SCB21-2. The region STM21-3 serves as a template.

The subblock SCB21-3 is positioned on the lower left of the current block CB11. The subblock SCB21-3 has a region STM21-4 adjacent to the subblock SCB21-3. The region STM21-4 serves as a template. The subblock SCB21-4 is positioned on the lower right of the current block CB11. The subblock SCB21-4 has no template, and it is thus not possible to perform template matching for the subblock SCB21-4.

However, it is only the area of the region of the subblock SCB21-4 that has no template in the upper portion of FIG. 22. It is the area of the regions of the subblocks SCB11-6 to SCB11-8, subblocks SCB11-10 to SCB11-12, and subblocks SCB11-14 to SCB11-16 that have no templates in a case where the current block CB11 is divided into 16 in FIG. 5. The area having no template in the upper portion of FIG. 22 is smaller than the area having no template in a case where the current block CB11 is divided into 16 in FIG. 5.

As described above, in a case where template matching is used to derive the motion information of CU, increasing subblocks in size makes it possible to decrease the area of subblocks having no templates.

Furthermore, the region STM21-1 and region STM21-2 adjacent to the subblock SCB21-1 on the upper portion of FIG. 22 is larger in size than the region STM11-1 and region STM11-2 adjacent to the subblock SCB11-1 in FIG. 5. This makes it possible to reduce uncertainty in a result of block matching.

In the lower portion of FIG. 22, bilateral matching is used to derive the motion information of the current block CB11, and the current block CB11 is divided into 16 subblocks SCB11-1 to SCB11-16. That is, in a case of bilateral matching, no template is used. This makes it possible to perform block matching with subblocks smaller in size than in a case of the upper portion of FIG. 22.

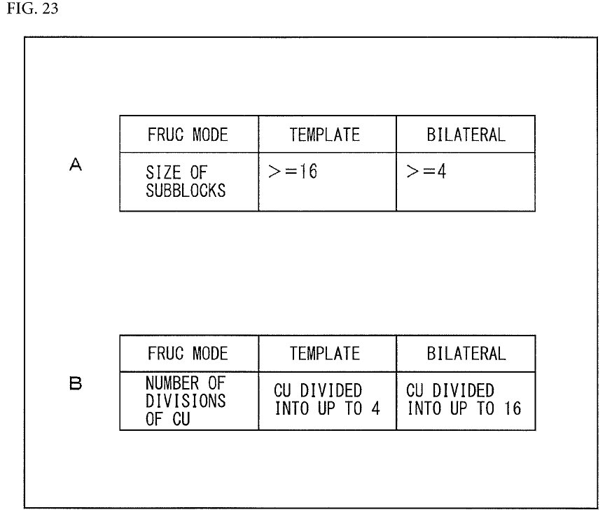

FIG. 23 is a diagram illustrating a table of the relationship between each type of block matching and the size of subblocks in the FRUC mode.

A of FIG. 23 illustrates the size of a subblock supported by each block matching in a case of designation by size. Template matching supports the size of subblocks greater than or equal to 16. Bilateral matching supports the size of subblocks greater than or equal to 4. It should be noted that the size of subblocks here is size in units of pixels.

B of FIG. 23 illustrates the number of subblocks into which Cu is divided that is supported by each block matching in a case of designation by the number of divisions. Template matching supports the size of subblocks allowing CU to be divided into up to four. Bilateral matching supports the size of subblocks allowing CU to be divided into up to 16.

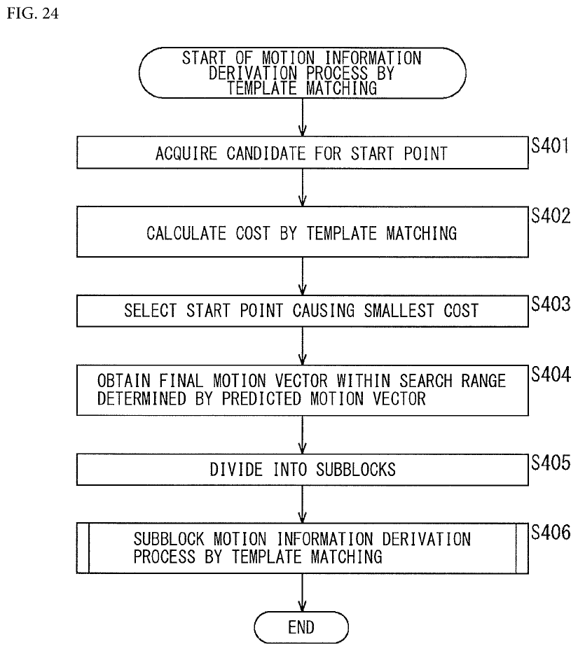

The size of these subblocks or the number of divisions of CU is designated in the image encoding device 11 when the prediction unit 30 of FIG. 6 divides a block in the motion information derivation process by template matching illustrated in FIG. 24. The size of subblocks or the number of divisions of CU for each block matching described above may be set in advance in split flag of the prediction information Pinfo. At this time, split flag of the prediction information Pinfo is referred to when a block is divided. The following describes the motion information derivation process by the image encoding device 11 by template matching with reference to the flowchart of FIG. 24.

In the motion information derivation process by template matching, the process in step S401 is performed by the candidate acquisition section 61, and the processes in step S402 to step S404 are performed by the motion vector derivation section 62.

It should be noted that these processes in step S401 to step S404 are similar to the processes in step S131 to step S134 in FIG. 10, and the description thereof is thus omitted.

In step S405, the prediction controller 51 divides CU to be encoded into subblocks. At this time, the prediction controller 51 designates the size of subblocks as 16 or more, or designates CU to be divided into up to 4.

In step S406, the template matching processor 52 performs a subblock motion information derivation process by template matching. In this subblock motion information derivation process by template matching, a process that is basically similar to the process described above with reference to FIG. 11 is performed, and the description thereof is thus omitted. When the process in step S406 derives the motion information for a subblock, the motion information derivation process by template matching ends.

In addition, in this case, when the motion information derivation process by bilateral matching described with reference to FIG. 13 is performed, the prediction controller 51 designates, in step S175, the size of subblocks as 4 or more or designates CU to be divided into up to 16.

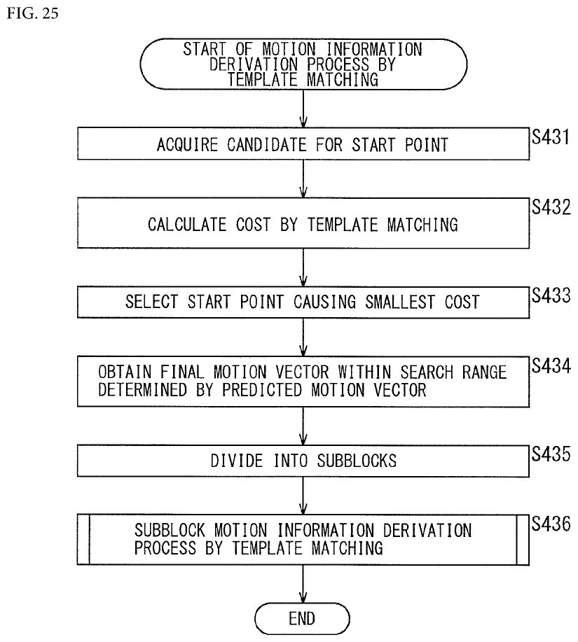

Meanwhile, in the image decoding device 201, the size of these subblocks or the number of divisions of CU is designated when the prediction unit 216 of FIG. 15 divides a block in the motion information derivation process by template matching illustrated in FIG. 25. The following describes the motion information derivation process by the image decoding device 201 by template matching with reference to the flowchart of FIG. 25.

In the motion information derivation process by template matching, the process in step S431 is performed by the candidate acquisition section 241, and the processes in step S432 to step S434 are performed by the motion vector derivation section 242.

It should be noted that these processes in step S431 to step S434 are similar to the processes in step S131 to step S134 in FIG. 10, and the description thereof is thus omitted.

In step S435, the prediction controller 231 divides CU to be encoded into subblocks. At this time, the prediction controller 231 designates the size of subblocks as 16 or more, or designates CU to be divided into up to 4.

In step S436, the template matching processor 232 performs a subblock motion information derivation process by template matching. In this subblock motion information derivation process by template matching, a process that is basically similar to the process described above with reference to FIG. 19 is performed, and the description thereof is thus omitted. When the process in step S436 derives the motion information for a subblock, the motion information derivation process by template matching ends.

In addition, in this case, when the motion information derivation process by bilateral matching described with reference to FIG. 21 is performed, the prediction controller 231 designates, in step S315, the size of subblocks as 4 or more or designates CU to be divided into up to 16.

As described above, the size of subblocks is increased in a case of template matching, and it is thus possible to improve the derivation accuracy of the motion vector of a subblock. Increasing the derivation accuracy of motion vectors also allows the accuracy of motion compensation to be increased.

It should be noted that the first embodiment and the second embodiment may be combined. That is, in a case where template matching is used to derive the motion information of CU, the size of subblocks may be increased, and then bilateral matching may be used for a subblock having no template.

### Third Embodiment

### <Block Matching of Subblocks in Case of Bilateral Matching>

In the first embodiment, an example has been described in which not only template matching, but also bilateral matching are used for a subblock in accordance with the position of the subblock in the CU when the motion information of CU is derived by template matching.

In contrast, in a third embodiment, a case where the motion information of CU is derived by bilateral matching is described.

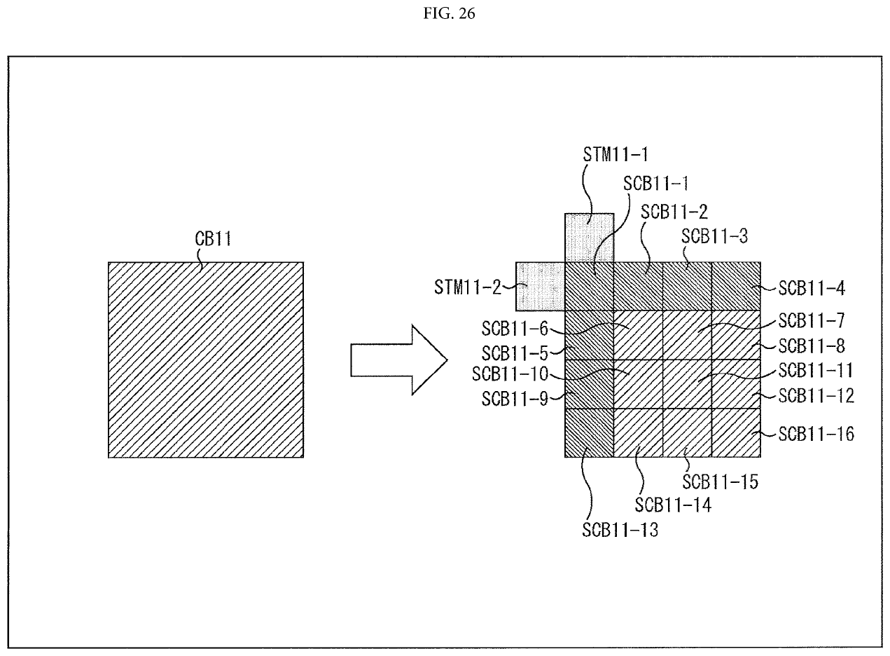

FIG. 26 is a diagram illustrating an example of bilateral matching performed in units of subblocks. It should be noted that, in FIG. 26, portions corresponding to those in the case in FIG. 4 are denoted with the same reference numerals, and the description thereof is omitted as appropriate.

The left portion of FIG. 26 illustrates the current block CB11.

The right side of FIG. 26 illustrates subblocks SCB11-1 to SCB11-16 obtained by dividing the current block CB11 into 16. Among the subblocks, the subblock SCB11-1 to the subblock SCB11-4 are the subblocks positioned on the uppermost portion of the current block CB11. Among the subblocks, the subblocks SCB11-1, SCB11-5, SCB11-9, and SCB11-13 are the blocks positioned on the leftmost portion of the current block CB11.

In addition, a region STM11-1 and a region STM11-2 are illustrated that are adjacent to the subblock SCB11-1 positioned on the upper left position of the current block CB11 and are templates used for the template matching of the subblock SCB11-1.

As described above, in the FRUC mode studied in JVET, the motion information is derived in CUs by using block matching described above. Then, a block is further divided, and block matching is performed in units of subblocks to derive the motion information in units of subblocks.

That is, in a case where bilateral matching is used to derive the motion information of CU, the same bilateral matching as that of the CU is used in subblocks, and the motion information of a subblock is derived.

However, when the motion information of CU is derived by bilateral matching, it is sometimes more favorable to use not only bilateral matching, but also template matching to derive the motion vector of a subblock.

It is sometimes more favorable to use template matching to derive the motion information of the subblocks on the uppermost portion and the subblocks on the leftmost portion of the current block CB11 in FIG. 26. The subblocks on the leftmost portion are the subblocks SCB11-1 to SCB11-5, subblock SCB11-9, and subblock SCB11-13.

This is because the motion vector derived by template matching is more correct in a case where there is an adjacent template, and bilateral matching may be correct in a case where block matching is performed on the entire CU. This is because the motion of the image is basically based on the assumption that the image moves similarly to an object at the close position.

In cases of these conditions, the use of bilateral matching in subblocks may result in an incorrect motion vector.

Accordingly, in the third embodiment of the present technology, when the motion information of CU is derived by bilateral matching, template matching is used for a subblock having a template to derive the motion vector of the subblock.

For the subblocks SCB11-1 to SCB11-5, subblock SCB11-9, and subblock

SCB11-13 each having the template illustrated in FIG. 26, the motion vectors are derived by template matching. For the subblocks SCB11-6 to SCB11-8, subblocks SCB11-10 to SCB11-12, and subblocks SCB11-14 to SCB11-16 each having no template, the motion vectors are derived by bilateral matching.

That is, to derive the motion vectors of the subblocks included in CU for which the motion vectors are derived by bilateral matching, any one of template matching or bilateral matching is used in accordance with whether or not the subblocks have templates. Alternatively, to derive the motion vectors of the subblocks included in CU for which the motion vectors are derived by bilateral matching, any one of template matching or bilateral matching is used in accordance with the positions of the subblocks in the CU.

This allows the derivation accuracy of the motion vectors of subblocks to be improved. Increasing the derivation accuracy of motion vectors also allows the accuracy of motion compensation to be increased.

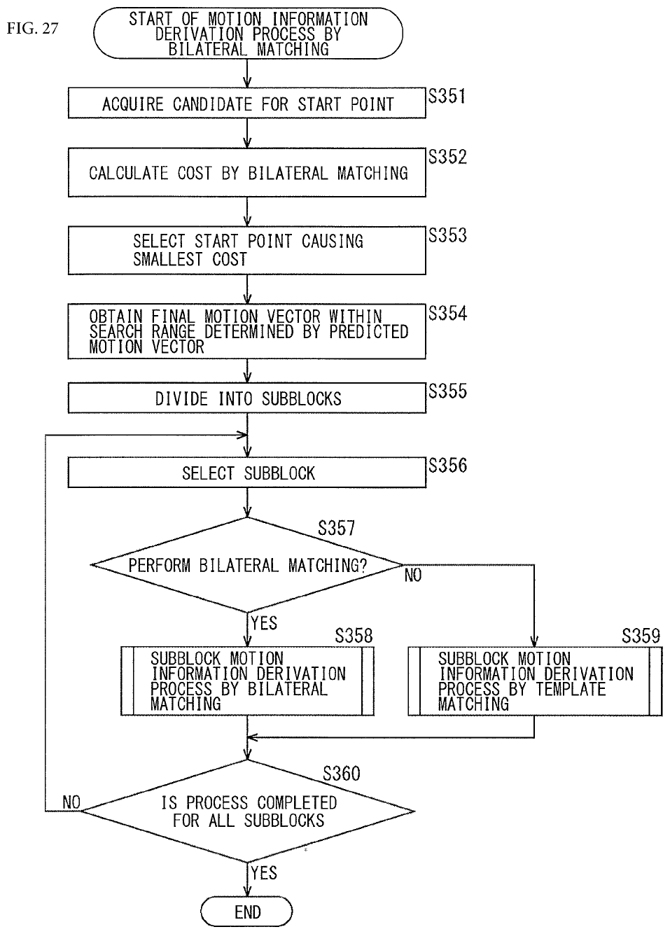

The following describes the motion information derivation process by the image encoding device 11 by bilateral matching with reference to the flowchart of FIG. 27.

In the motion information derivation process by bilateral matching, the process in step S351 is performed by the candidate acquisition section 71, and the processes in step S352 to step S354 are performed by the motion vector derivation section 72.

The process in step S355 is performed by the prediction controller 51. It should be noted that these processes in step S351 to step S355 are similar to the processes in step S171 to step S175 in FIG. 13, and the description thereof is thus omitted.

In step S356, the prediction controller 51 selects one subblock that is to be processed. In step S357, the prediction controller 51 determines whether or not to perform bilateral matching to derive the predicted motion vector of the selected subblock, on the basis of the position of the subblock in the CU to be encoded.

In a case where the position of the subblock in the CU to be encoded is a position other than the uppermost and leftmost portions of the CU to be encoded, the prediction controller 51 determines in step S357 that bilateral matching is performed, and the process proceeds to step S358.

In step S358, the bilateral matching processor 53 performs a subblock motion information derivation process by bilateral matching. In step S358, a process is performed that is basically similar to the subblock motion information derivation process by bilateral matching of FIG. 12. This process derives the motion information of the subblock selected in step S356 by using bilateral matching.

In a case where the position of the subblock in the CU to be encoded is the uppermost or leftmost portion of the CU to be encoded, the prediction controller 51 determines in step S357 that template matching is performed, and the process proceeds to step S359.

In step S359, the template matching processor 52 performs a subblock motion information derivation process by template matching. In step S359, a process is performed that is basically similar to the subblock motion information derivation process by template matching of FIG. 11. This process derives the motion information of the subblock selected in step S356 by using template matching.

Once the motion information of the subblock is derived in step S358 or step S359, the process proceeds to step S360.

In step S360, the prediction controller 51 determines whether or not the process is completed for all the subblocks of CU to be encoded. In a case where it is determined in step S360 that the process for all the subblocks of CU to be encoded has not yet been completed, the process returns to step S356, and the subsequent processes are repeated.

In a case where it is determined in step S360 that the process for all the subblocks of CU to be encoded is completed, the motion information derivation process by bilateral matching ends.

As described above, in the image encoding device 11, the motion information is derived in the template mode in accordance with the position (or the presence or absence of a template) of a subblock in CU for which the motion information is derived by using bilateral matching. This allows the derivation accuracy of the motion information of a subblock having a template to be improved.

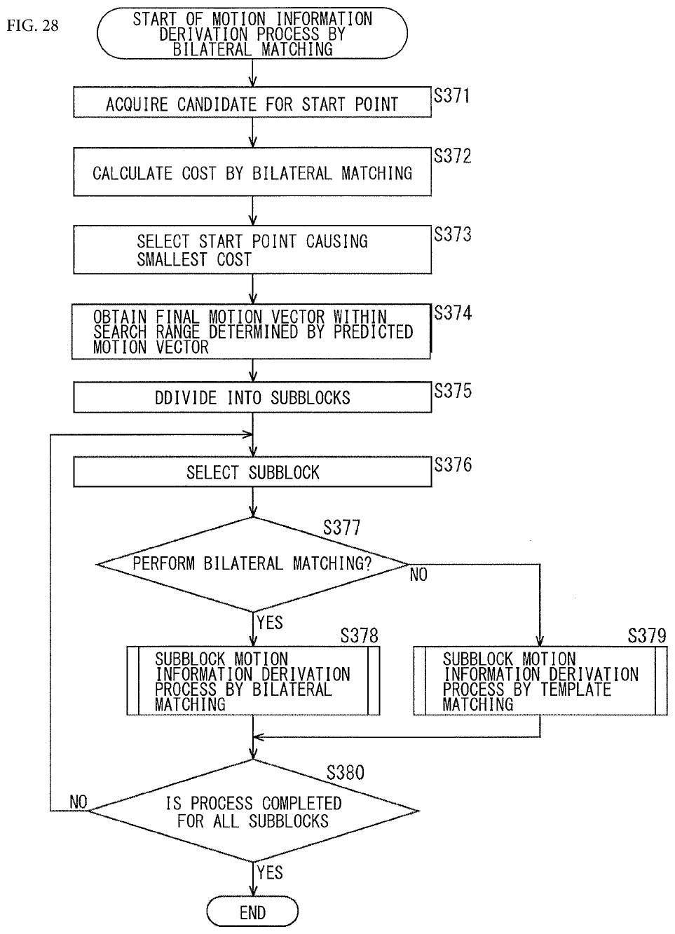

Next, the motion information derivation process by the image decoding device 201 by bilateral matching is described with reference to the flowchart of FIG. 28.

In the motion information derivation process by bilateral matching, the process in step S371 is performed by the candidate acquisition section 251. In addition, the processes in step S372 to step S374 are performed by the motion vector derivation section 252, and the processes in step S375 to S377 are performed by the prediction controller 231.

The process in step S378 is performed by the bilateral matching processor 233, the process in step S379 is performed by the template matching processor 232, and the process in step S380 is performed by the prediction controller 231.

It should be noted that these processes in step S371 to step S380 are similar to the processes in step S351 to step S360 in FIG. 27, and the description thereof is thus omitted.

It should be noted that the first embodiment and the third embodiment may be combined. In a case where template matching is used to derive the motion vector of CU, bilateral matching is used to derive the motion vector of a subblock having no template. In contrast, in a case where bilateral matching is used to derive the motion vector of CU, template matching is used to derive the motion vector a subblock having a template.

That is, not only the block matching used to derive the motion vector of CU, but also block matching different from the block matching used may be used to derive the motion vector of a subblock of CU.

### Fourth Embodiment

### <Size of Subblocks and POC Distance>

As described in the first to third embodiments, the motion information is first derived in units of CUs, and after the process of the CUs, the motion information of a subblock is derived.

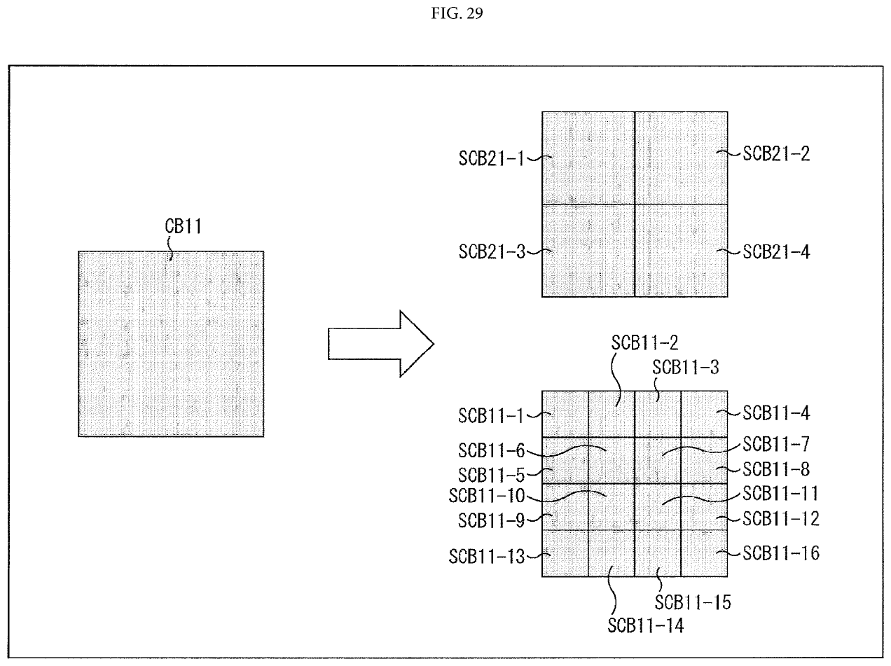

FIG. 29 is a diagram illustrating a size example of subblocks in CU. It should be noted that, in FIG. 29, portions corresponding to those in the case in FIG. 22 are denoted with the same reference numerals, and the description thereof is omitted as appropriate.

On the upper right of FIG. 29, the current block CB11 is divided into the four subblocks SCB21-1 to SCB21-4.

On the lower right of FIG. 29, the current block CB11 is divided into the 16 subblocks SCB11-1 to SCB11-16.

Generally, as CU is divided into more subblocks, the processing amount increases because block matching for each of the divided subblocks is necessary. Therefore, the processing amount is relatively larger in a case where CU is divided into 16 subblocks than in a case where CU is divided into four subblocks.

In a case of the FRUC mode, block matching is also performed on the image decoding device 201 side, and especially the increase in processing amount on the image decoding device 201 side is thus a large barrier to achieving a real time process in the reproduction of moving images.

Further, the description above does not mention the size of CU, but the size of a subblock is smaller than the size of CU. Accordingly, the processing amount of the FRUC mode for CU smaller in size is relatively large.

Here, the motion of a moving image is more complicated as the time intervals between the frame are longer. As the motion is more complicated, it is more desirable to perform block matching with smaller blocks.

POC (Picture Order Count) distance is now defined that indicates the time intervals between frames. POC is a number indicating the order in which frames are displayed, and sequentially represents the frames arranged at the frame intervals corresponding to the frame rate. The absolute value of the difference from the POC of the current picture to the POC of the frame to be referred to is POC distance.

It is possible to acquire POC from slice_pic_order_cnt_lsb information of a slice header in a case of HEVC as an example.

It should be noted that the semantics of slice_pic_order_cnt_lsb is as follows, but it may be omitted that a remainder is given.

slice_pic_order_cnt_lsb specifies the picture order count modulo MaxPicOrderCntLsb for the current picture.

In a fourth embodiment of the present technology, the size of subblocks is changed in accordance with the POC distance.

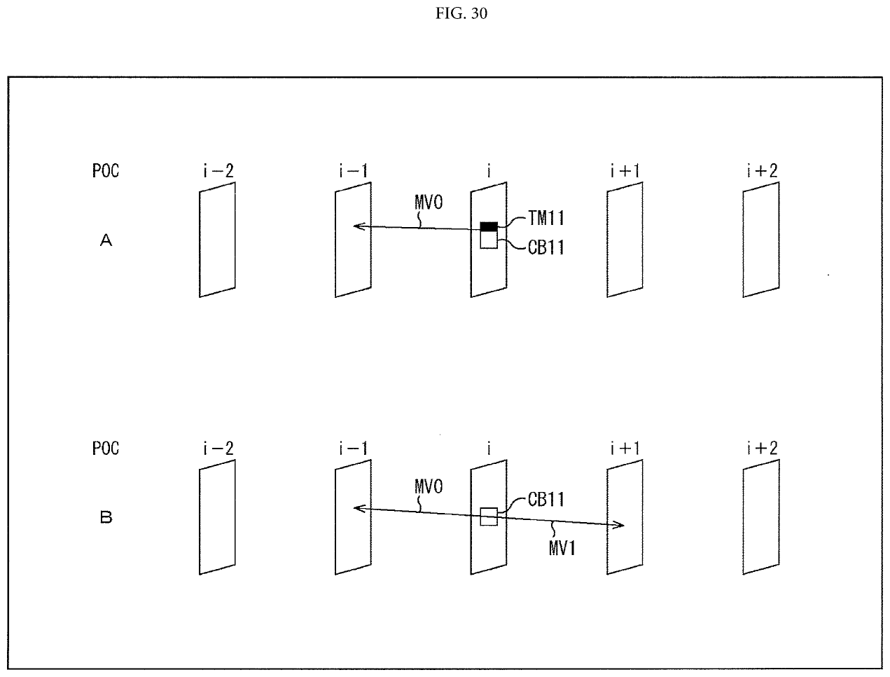

FIG. 30 is a diagram illustrating an example of block matching in a case of a POC distance of 1. In the example of FIG. 30, frames are illustrated that are arranged in the order of POC(=i−2, i−1, i, i+1, and i+2).

A of FIG. 30 is a diagram illustrating an example of template matching in a case of a POC distance of 1. A of FIG. 30 illustrates the current block CB11 and the region TM11 adjacent to the current block CB11 on the frame of POC=i. In addition, the motion vector MV0 of the current block CB11 that has the frame of POC=i as a start point and the frame of POC=i−1 as an end point is illustrated.

In this case, the current POC is i, and the POC to be referred to is i−1. The POC distance is thus |(i−1)|=1.

B of FIG. 30 is a diagram illustrating an example of bilateral matching in a case of a POC distance of 1. B of FIG. 30 illustrates the current block CB11 on the frame of POC=i and the motion vector MV0 of the current block CB11 that has the frame of POC=i as a start point and the frame of POC=i−1 as an end point. In addition, the motion vector MV1 of the current block CB11 that has the frame of POC=i as a start point and the frame of POC=i+1 as an end point is illustrated.

In this case, the current POC is i, and the POC to be referred to is i−1 or i+1. Thus, the POC distance is 1 for any of them as in |(i−1)|=1 or |(i+1)|=1.

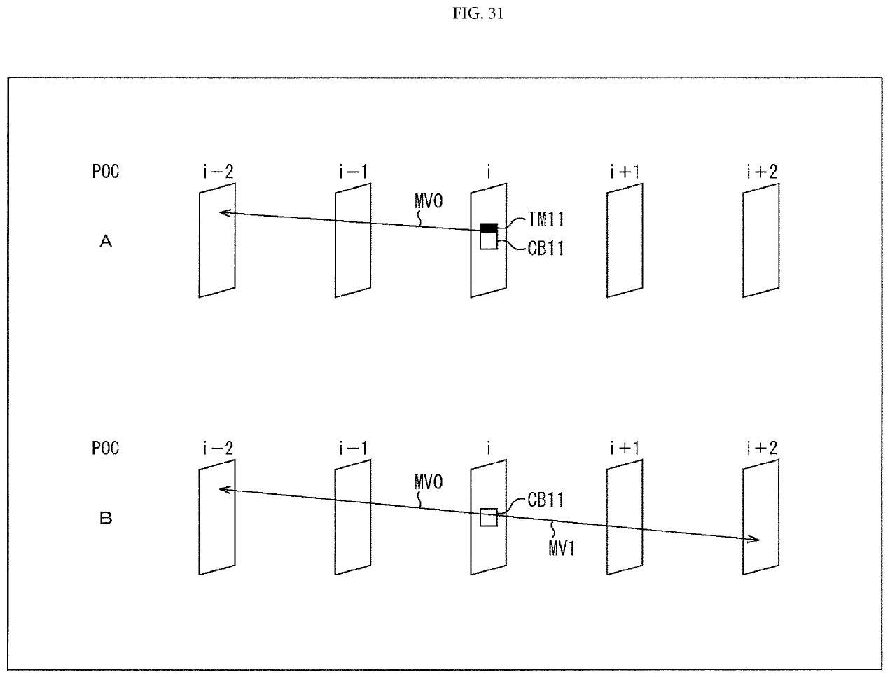

FIG. 31 is a diagram illustrating an example of block matching in a case of a POC distance of 2. It should be noted that, in FIG. 31, portions corresponding to those in the case in FIG. 30 are denoted with the same reference numerals, and the description thereof is omitted as appropriate.

A of FIG. 31 is a diagram illustrating an example of template matching in a case of a POC distance of 2. A of FIG. 31 illustrates the motion vector MV0 of the current block CB11 that has the frame of POC=i as a start point and the frame of POC=i−2 as an end point in addition to the current block CB11 and the region TM 11 on the frame of POC=i.

In this case, the current POC is i, and the POC to be referred to is i−2. The POC distance is thus |(i−2)|=2.

B of FIG. 31 is a diagram illustrating an example of bilateral matching in a case of a POC distance of 2. B of FIG. 31 illustrates the current block CB11 on the frame of POC=i and the motion vector MV0 of the current block CB11 that has the frame of POC=i as a start point and the frame of POC=i−2 as an end point. In addition, the motion vector MV1 of the current block CB11 that has the frame of POC=i as a start point and the frame of POC=i+2 as an end point is illustrated.

In this case, the current POC is i, and the POC to be referred to is i−2 or i+2. Thus, the POC distance is 2 for any of them as in |(i−2)|=2 or |(i+2)|=2.

In a case of FIG. 31, the POC distance is longer and the motion is more complicated than in a case of FIG. 30, and the division into smaller subblocks is thus desired.

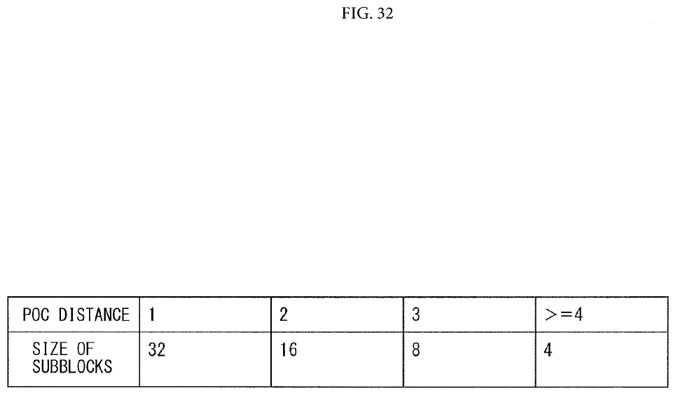

FIG. 32 is a diagram illustrating an example of the relationship between the POC distance and the subblock size.

In FIG. 32, in a case where the POC distance is 1, the supported size of subblocks is 32. In a case where the POC distance is 2, the supported size of subblocks is 16. In a case where the POC distance is 3, the supported size of subblocks is 8. In a case where the POC distance is 4 or more, the supported size of subblocks is 4. Here, the size of subblocks is size in units of pixels.

In a case where the POC distance is short like 1, subblocks are relatively large in size to keep a small processing amount because the motion is not complicated, but expected to be simple. In contrast, in a case where the POC distance is long like 4 or more, subblocks are relatively small in size to allow the motion to be examined more finely because the motion is expected to be complicated.

It is also possible to designate the size of subblocks by designating the number of divisions of CU.

The size of subblocks or the number of divisions is designated by the prediction controller 51 of the prediction unit 30 of FIG. 6 in the image encoding device 11. These are designated in step S405 in the motion information derivation process by template matching of FIG. 24 or step S175 in the motion information derivation process by bilateral matching of FIG. 13.

In addition, the size of subblocks or the number of divisions is designated by the prediction controller 231 of the prediction unit 216 of FIG. 15 in the image decoding device 201. These are designated in step S435 in the motion information derivation process by template matching of FIG. 25 or step S315 in the motion information derivation process by bilateral matching of FIG. 21.

The size of subblocks or the number of divisions described above may also be set in advance in split flag of the prediction information Pinfo. At this time, split flag of the prediction information Pinfo is referred to when a block is divided.

### Fifth Embodiment

### <Size and Number of Divisions of CU>

As described above in the fourth embodiment, the processing amount differs in accordance with the size of CU.

Accordingly, in a fifth embodiment of the present technology, CU is not divided into subblocks (i.e., division is prohibited) or the number of subblocks into which CU is divided is increased or decreased (changed) in accordance with the size of CU and the POC distance. It should be noted that not dividing CU into subblocks, that is, prohibiting CU from being divided into subblocks also means dividing CU into one subblock with the number of divided subblocks set at 0.

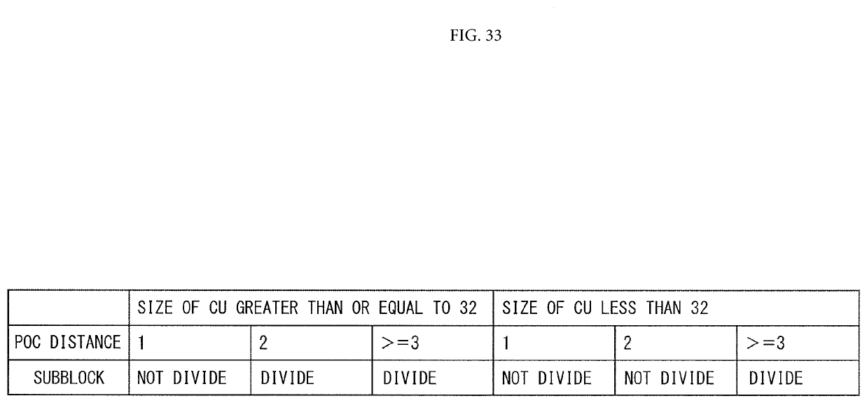

FIG. 33 is a diagram illustrating an example of the relationship between the size of CU, the POC distance, and the division into subblocks.

In FIG. 33, in a case where the size of CU is 32 or more, the CU is not divided into subblocks when the POC distance is 1. When the POC distance is 2 or 3 or more, the CU is divided into subblocks. In addition, in a case where the size of CU is less than 32, the CU is not divided into subblocks when the POC distance is 1 and 2. When the POC distance is 3 or more, the CU is divided into subblocks.

In a case where CU is small in size like less than 32, the processing amount is expected to increase. Therefore, the division into subblocks is performed only when the POC distance is 3 or more. The division into subblocks is not performed when the POC distance is 2 or less.

In a case where CU is large in size like 32 or more, the processing amount is expected to be small. Therefore, the division into subblocks is performed when the POC distance is 2 or 3 or more.

Similarly to the fourth embodiment, the number of divided subblocks is designated by the prediction controller 51 of the prediction unit 30 of FIG. 6 in the image encoding device 11. These are designated in step S405 in the motion information derivation process by template matching of FIG. 24 or step S175 in the motion information derivation process by bilateral matching of FIG. 13.

In addition, the number of divided subblocks is designated by the prediction controller 231 of the prediction unit 216 of FIG. 15 in the image decoding device 201. These are designated in step S435 in the motion information derivation process by template matching of FIG. 25 or step S315 in the motion information derivation process by bilateral matching of FIG. 21.

It should be noted that, in a case of the fourth embodiment or a case of the fifth embodiment, the size of subblocks or the number of divided subblocks may be designated as follows in the image encoding device 11 and the image decoding device 201. In the image encoding device 11, the designation may be performed by the prediction controller 51 of the prediction unit 30 of FIG. 6 in step S136 in the motion information derivation process by template matching in FIG. 10 or in step S356 in the motion information derivation process by bilateral matching in FIG. 27.

In addition, the size of subblocks or the number of divided subblocks is designated by the prediction controller 231 of the prediction unit 216 of FIG. 15 in the image decoding device 201. These may be designated in step S276 in the motion information derivation process by template matching of FIG. 18 or step S376 in the motion information derivation process by bilateral matching of FIG. 28.

As described above, according to the fourth and fifth embodiments of the present technology, it is possible to reduce the processing amount of the block matching of subblocks that is expected to be large.

In addition, in block matching having long POC distance in which the motion is expected to be complicated, allowing subblocks to be small in size enables block matching to be performed with higher accuracy.

In addition, the processing amount is expected to be large in a case where CU is small in size. The motion is expected to be simple in a case where the POC distance is short. Accordingly, it is possible in those cases to reduce the processing amount without subblock division.

### Sixth Embodiment

### <Block Matching Type, and Size and Number of Divisions of CU>

In a sixth embodiment, the POC distance and the number of divided subblocks indicated in the fourth and fifth embodiments are combined with the types of block matching described above in the first to third embodiments.

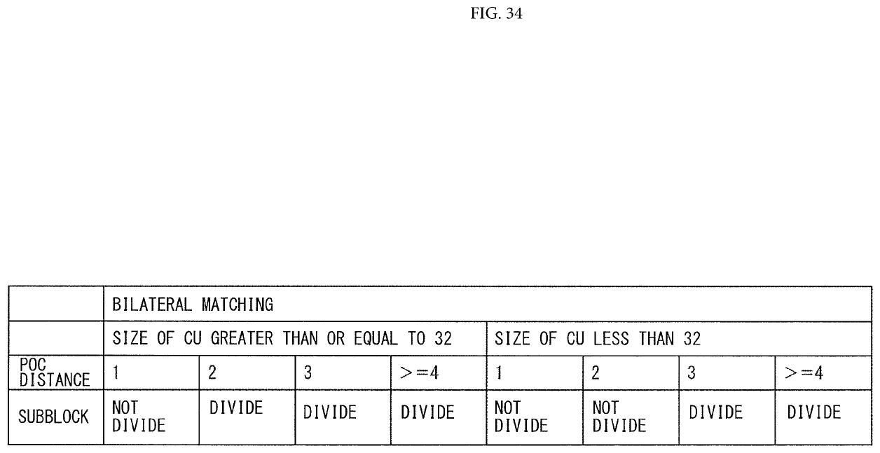

FIG. 34 is a diagram illustrating an example of the relationship between the bilateral matching, the size of CU, the POC distance, and the division into subblocks.

In FIG. 34, in a case where the size of CU is 32 or more in bilateral matching, the CU is not divided into subblocks (division is prohibited) when the POC distance is 1. When the POC distance is 2 to 4 or more, the CU is divided into subblocks. In addition, in a case where the size of CU is less than 32 in bilateral matching, the CU is not divided into subblocks (division is prohibited) when the POC distance is 1 and 2. When the POC distance is 3 and 4 or more, the CU is divided into subblocks.

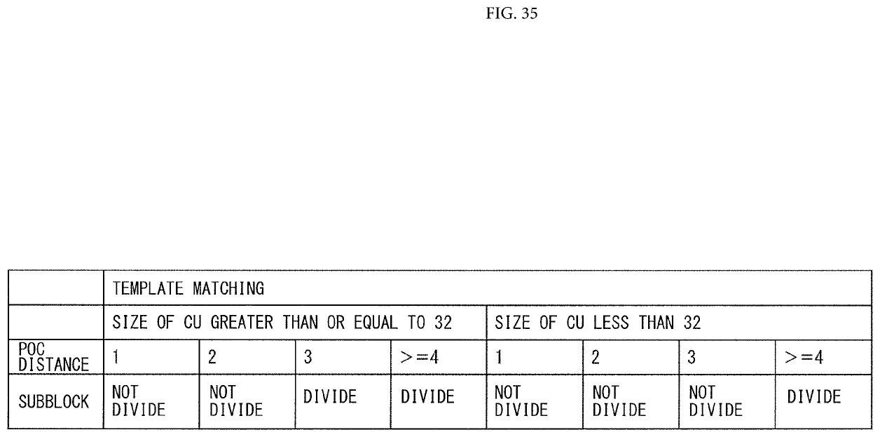

FIG. 35 is a diagram illustrating an example of the relationship between the template matching, the size of CU, the POC distance, and the division into subblocks.

In FIG. 35, in a case where the size of CU is 32 or more in template matching, the CU is not divided into subblocks when the POC distance is 1 and 2. When the POC distance is 3 or 4 or more, the CU is divided into subblocks. In addition, in a case where the size of CU is less than 32 in template matching, the CU is not divided into subblocks when the POC distance is 1 to 3. When the POC distance is 4 or more, the CU is divided into subblocks.

Template matching is considered to have lower derivation accuracy of motion vectors than that of bilateral matching because only the subblocks positioned on the uppermost and leftmost portions of CU have templates. Therefore, in FIG. 35, the condition that the division into subblocks is not performed is added.

In contrast, when CU is small in size, further division is expected to excessively increase the processing amount, and therefore, it is determined in accordance with the size of the CU whether or not the CU is divided.

Further, in a case of matching where the POC distance is long, the motion is complicated. Accordingly, the division into subblocks allows the derivation accuracy of the motion vector to be increased.

The number of divided subblocks is designated by the prediction controller 51 of the prediction unit 30 of FIG. 6 in the image encoding device 11. These are designated in step S136 in the motion information derivation process by template matching of FIG. 10 or step S356 in the motion information derivation process by bilateral matching of FIG. 27.

In addition, the designation is performed by the prediction controller 231 of the prediction unit 216 of FIG. 15 in the image decoding device 201. These are designated in step S276 in the motion information derivation process by template matching of FIG. 18 or step S376 in the motion information derivation process by bilateral matching of FIG. 28.

The size of subblocks or the number of divisions in these cases may also be set in advance in split flag of the prediction information Pinfo. At this time, split flag of the prediction information Pinfo is referred to when a block is divided.

It should be noted that the size of subblocks or the number of divided subblocks may be designated similarly to the fourth and fifth embodiments. In the image encoding device 11, the designation may be performed by the prediction controller 51 of the prediction unit 30 of FIG. 6 in step S405 in the motion information derivation process by template matching in FIG. 24 or in step S175 in the motion information derivation process by bilateral matching in FIG. 13.

In addition, the size of subblocks or the number of divided subblocks may be designated by the prediction controller 231 of the prediction unit 216 of FIG. 15 in the image decoding device 201. These may be designated in step S435 in the motion information derivation process by template matching of FIG. 25 or step S315 in the motion information derivation process by bilateral matching of FIG. 21.

As described above, according to the present technology, it is possible to improve the accuracy of motion prediction. Thus, the accuracy of motion compensation is also improved.

In addition, the present technology described above is applicable, for example, to various electronic devices and systems such as a server, a network system, a television receiver, a personal computer, a mobile phone, a recording/reproducing device, an imaging device, and a portable device. It should be noted that it is also naturally possible to combine the embodiments described above as appropriate.

### <Configuration Example of Computer>

Incidentally, it is possible to execute the above-described series of processes with hardware or software. In a case where the series of processes is executed with software, a program included in the software is installed in a computer. Here, the computer includes, for example, a computer that is incorporated in dedicated hardware, a general-purpose computer that is able to execute various functions by installing various programs, and the like.

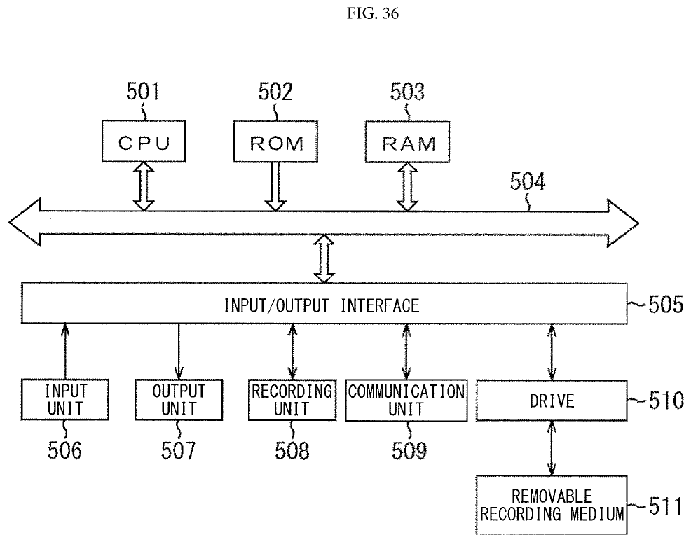

FIG. 36 is a block diagram illustrating a configuration example of the hardware of a computer that executes the above-described series of processes with a program.

In the computer, CPU (Central Processing Unit) 501, ROM (Read Only Memory) 502, and RAM (Random Access Memory) 503 are coupled to each other by a bus 504.

Further, an input/output interface 505 is coupled to the bus 504. An input unit 506, an output unit 507, a recording unit 508, a communication unit 509, and a drive 510 are coupled to the input/output interface 505.

The input unit 506 includes a keyboard, a mouse, a microphone, an imaging element, and the like. The output unit 507 includes a display, a speaker array, and the like. The recording unit 508 includes a hard disk, a non-volatile memory, and the like. The communication unit 509 includes a network interface, and the like. The drive 510 drives a removable recording medium 511 such as a magnetic disk, an optical disc, a magneto-optical disk, or a semiconductor memory.

In the computer configured as described above, the CPU 501 loads a program that is recorded, for example, in the recording unit 508 onto the RAM 503 via the input/output interface 505 and the bus 504, and executes the program, thereby performing the above-described series of processes.

For example, it is possible to record and provide programs to be executed by the computer (CPU 501) in the removable recording medium 511 that is a packaged medium or the like. In addition, it is possible to provide a program via a wired or wireless transmission medium such as a local area network, the Internet, or digital satellite broadcasting.

In the computer, mounting the removable recording medium 511 onto the drive 510 makes it possible to install programs in the recording unit 508 via the input/output interface 505. In addition, it is possible to cause the communication unit 509 to receive programs via a wired or wireless transmission medium, and install the programs in the recording unit 508. In addition, it is possible install programs in advance in the ROM 502 or the recording unit 508.

It should be noted that a program executed by the computer may be a program in which processes are chronologically performed in the order described herein or may be a program in which processes performed in parallel or at necessary timing such as when the processes are invoked.

In addition, the embodiment of the present technology is not limited to the embodiment described above, but it is possible to alter the embodiment of the present technology in various manners without departing from the subject matter of the present technology.

For example, it is possible for the present technology to adopt the configuration of cloud computing in which one function is distributed to a plurality of devices via a network and processed in cooperation.

In addition, it is possible execute the respective steps described in the flowcharts described above with one device, and it is also possible to distribute the respective steps to a plurality of devices for execution.

Further, in a case where a plurality of processes is included in one step, it is possible to execute the plurality of processes included in the one step with one device, and it is also possible to distribute the plurality of processes to a plurality of devices for execution.

In addition, the effects described herein are merely examples, but not limitative. Any other effects may also be included.

Further, it is also possible to configure the present technology as below.

(1)

An image processing device including

a prediction unit that derives, by first block matching using a reference image, a motion vector of a block to be processed, and derives a motion vector of a portion of subblocks by using second block matching different from the first block matching, the subblocks being included in the block.

(2)

The image processing device according to (1), in which the first block matching and the second block matching include template matching or bilateral matching, the template matching being based on an image including the block and the reference image, the bilateral matching being based on the reference images different from each other in time.

(3)

The image processing device according to (2), in which the prediction unit determines, on the basis of a position of the subblock in the block, whether to derive the motion vector of the subblock by using the first block matching or derive the motion vector of the subblock by using the second block matching.

(4)

The image processing device according to (3), in which the prediction unit derives the motion vector of the subblock by the template matching in a case where the position of the subblock in the block is a leftmost or uppermost portion of the block.

(5)

The image processing device according to (2), in which the prediction unit determines, on the basis of whether or not the subblock is adjacent to a decoded block, whether to derive the motion vector of the subblock by using the first block matching or derive the motion vector of the subblock by using the second block matching.

(6)

The image processing device according to (5), in which the prediction unit derives the motion vector of the subblock by the template matching in a case where the subblock is adjacent to the decoded block.

(7)

The image processing device according to (2), in which, in a case where the template matching is performed as the first block matching to derive the motion vector of the block, the prediction unit divides the block into the subblocks larger in size than in a case where the motion vector of the block is derived by the bilateral matching.

(8)

The image processing device according to any of (1) to (7), in which the prediction unit prohibits the block from being divided into the subblocks, or increases or decreases a number of divisions of the block for dividing the block into the subblocks, in accordance with POC distance, the POC distance indicating a time interval between images used for the first block matching for deriving the motion vector of the block.

(9)

The image processing device according to (8), in which the prediction unit prohibits the block from being divided, or increases or decreases the number of divisions, in accordance with the POC distance and size of the block.

(10)

The image processing device according to (8), in which the prediction unit prohibits the block from being divided, or increases or decreases the number of divisions, in accordance with the POC distance, size of the block, and the first block matching used to derive the motion vector of the block.

(11)

An image processing method including, by an image processing device,

deriving, by first block matching using a reference image, a motion vector of a block to be processed, and deriving a motion vector of a portion of subblocks by using second block matching different from the first block matching, the subblocks being included in the block.

(12)

An image processing device including

a prediction unit that derives, by block matching using a reference image, a motion vector of a block to be processed, and prohibits the block from being divided into subblocks, or increases or decreases a number of divisions of the block for dividing the block into subblocks, in accordance with POC distance, the POC distance indicating a time interval between images used for the block matching.

(13)

The image processing device according to (12), in which the prediction unit prohibits the block from being divided, or increases or decreases the number of divisions, in accordance with the POC distance and size of the block.

(14)

The image processing device according to (12), in which the prediction unit prohibits the block from being divided, or increases or decreases the number of divisions, in accordance with the POC distance, size of the block, and the block matching used to derive the motion vector of the block.

(15)

The image processing device according to (12), in which the block matching includes template matching or bilateral matching, the template matching being based on an image including the block and the reference image, the bilateral matching being based on the reference images different from each other in time.

(16)

An image processing method including, by an image processing device,

deriving, by block matching using a reference image, a motion vector of a block to be processed, and prohibiting the block from being divided into subblocks, or increasing or decreasing a number of divisions of the block for dividing the block into subblocks, in accordance with POC distance, the POC distance indicating a time interval between images used for the block matching.

### REFERENCE SIGNS LIST

11 Image encoding device, 21 Control unit, 30 Prediction unit, 51 Prediction controller, 52 Template matching processor, 53 Bilateral matching processor, 61 Candidate acquisition section, 62 Motion vector derivation section, 71 Candidate acquisition section, 72 Motion vector derivation section, 201 Image decoding device, 211 Decoding unit, 216 Prediction unit, 231 Prediction controller, 232 Template matching processor, 233 Bilateral matching processor, 241 Candidate acquisition section, 242 Motion vector derivation section, 251 Candidate acquisition section, 252 Motion vector derivation section

1. An image processing device comprising
a prediction unit that derives, by first block matching using a reference image, a motion vector of a block to be processed, and derives a motion vector of a portion of subblocks by using second block matching different from the first block matching, the subblocks being included in the block.

2. The image processing device according to claim 1, wherein the first block matching and the second block matching include template matching or bilateral matching, the template matching being based on an image including the block and the reference image, the bilateral matching being based on the reference images different from each other in time.

3. The image processing device according to claim 2, wherein the prediction unit determines, on a basis of a position of the subblock in the block, whether to derive the motion vector of the subblock by using the first block matching or derive the motion vector of the subblock by using the second block matching.

4. The image processing device according to claim 3, wherein the prediction unit derives the motion vector of the subblock by the template matching in a case where the position of the subblock in the block is a leftmost or uppermost portion of the block.

5. The image processing device according to claim 2, wherein the prediction unit determines, on a basis of whether or not the subblock is adjacent to a decoded block, whether to derive the motion vector of the subblock by using the first block matching or derive the motion vector of the subblock by using the second block matching.

6. The image processing device according to claim 5, wherein the prediction unit derives the motion vector of the subblock by the template matching in a case where the subblock is adjacent to the decoded block.

7. The image processing device according to claim 2, wherein, in a case where the template matching is performed as the first block matching to derive the motion vector of the block, the prediction unit divides the block into the subblocks larger in size than in a case where the motion vector of the block is derived by the bilateral matching.

8. The image processing device according to claim 1, wherein the prediction unit prohibits the block from being divided into the subblocks, or increases or decreases a number of divisions of the block for dividing the block into the subblocks, in accordance with POC distance, the POC distance indicating a time interval between images used for the first block matching for deriving the motion vector of the block.

9. The image processing device according to claim 8, wherein the prediction unit prohibits the block from being divided, or increases or decreases the number of divisions, in accordance with the POC distance and size of the block.

10. The image processing device according to claim 8, wherein the prediction unit prohibits the block from being divided, or increases or decreases the number of divisions, in accordance with the POC distance, size of the block, and the first block matching used to derive the motion vector of the block.

11. An image processing method comprising, by an image processing device,
deriving, by first block matching using a reference image, a motion vector of a block to be processed, and deriving a motion vector of a portion of subblocks by using second block matching different from the first block matching, the subblocks being included in the block.

12. An image processing device comprising
a prediction unit that derives, by block matching using a reference image, a motion vector of a block to be processed, and prohibits the block from being divided into subblocks, or increases or decreases a number of divisions of the block for dividing the block into subblocks, in accordance with POC distance, the POC distance indicating a time interval between images used for the block matching.

13. The image processing device according to claim 12, wherein the prediction unit prohibits the block from being divided, or increases or decreases the number of divisions, in accordance with the POC distance and size of the block.

14. The image processing device according to claim 12, wherein the prediction unit prohibits the block from being divided, or increases or decreases the number of divisions, in accordance with the POC distance, size of the block, and the block matching used to derive the motion vector of the block.

15. The image processing device according to claim 12, wherein the block matching includes template matching or bilateral matching, the template matching being based on an image including the block and the reference image, the bilateral matching being based on the reference images different from each other in time.

16. An image processing method comprising, by an image processing device,
deriving, by block matching using a reference image, a motion vector of a block to be processed, and prohibiting the block from being divided into subblocks, or increasing or decreasing a number of divisions of the block for dividing the block into subblocks, in accordance with POC distance, the POC distance indicating a time interval between images used for the block matching.
